(19) United States
(12) Patent Application Publication
(10) Pub. No.: US 2012/0249550 A1
(43) Pub. Date: Oct. 4, 2012

(54) Selective Transmission of Image Data Based on Device Attributes

(75) Inventors: Kurt Barton Akeley, Saratoga, CA (US); Yi-Ren Ng, Redwood City, CA (US); Kenneth Wayne Waters, San Jose, CA (US); Kayvon Fatahalian, San Francisco, CA (US); Timothy James Knight, Palo Alto, CA (US); Yuriy Aleksandrovich Romanenko, Campbell, CA (US); Chia-Kai Liang, Mountain View, CA (US); Colvin Pitts, Snohomish, WA (US); Thomas Hanley, Redwood City, CA (US); Mugur Marculescu, Los Altos, CA (US)

(73) Assignee: LYTRO, INC., Mountain View, CA (US)

(21) Appl. No.: 13/523,776

(22) Filed: Jun. 14, 2012

Related U.S. Application Data
(63) Continuation-in-part of application No. 13/155,882, filed on Jun. 8, 2011.
Application No. 13/155,882 is a continuation-in-part of application No. 12/703,367, filed on Feb. 10, 2010.
(60) Provisional application No. 61/170,620, filed on Apr. 18, 2009.
(60) Provisional application No. 61/655,790, filed on Jun. 5, 2012.

(51) Int. Cl. G06T 15/00; G06T 1/00; G06K 9/36

(52) U.S. Cl. 345/419; 382/276; 345/501

(57) ABSTRACT

A system and method are provided for storing, manipulating, and/or transmitting image data, such as light field photographs and the like, in a manner that efficiently delivers different capabilities and features based on device attributes, user requirements and preferences, context, and/or other factors. Acceleration structures are provided, which enable selective use of certain types of data (also referred to as “assets”) based on device attributes such as image size, desired functionality, user preference, and/or the like. In this manner, the system and method of the present invention takes into account specific attributes and parameters in determining which data should be included, so as to optimize transmission, storage, and/or rendering of image data, including light field data, to improve efficiency and avoid waste of resources.

### CROSS-REFERENCE TO RELATED APPLICATIONS

The present application claims priority as a continuation-in-part of U.S. Utility Application Serial No. 13/155,882 for “Storage and Transmission of Pictures Including Multiple Frames,” (Atty. Docket No. LYT009), filed Jun. 8, 2011, the disclosure of which is incorporated herein by reference.

The present application further claims priority as a continuation-in-part of U.S. Utility application Ser. No. 12/703,367 for “Light Field Camera Image, File and Configuration Data, and Method of Using, Storing and Communicating Same,” (Atty. Docket No. LYT3003), filed Feb. 10, 2010, the disclosure of which is incorporated herein by reference. U.S. Utility application Ser. No. 12/703,367 claims priority from U.S. Provisional Application Ser. No. 61/170,620 for “Light Field Camera Image, File and Configuration Data, and Method of Using, Storing and Communicating Same,” filed Apr. 18, 2009, the disclosure of which is incorporated herein by reference.

The present application claims priority from U.S. Provisional Application Ser. No. 61/655,790 for “Extending Light-Field Processing to Include Extended Depth of Field and Variable Center of Perspective,” (Atty. Docket No. LYT003-PROV), filed Jun. 5, 2012, the disclosure of which is incorporated herein by reference.

The present application is related to U.S. Utility Application Serial No. 13/027,946 for “3D Light Field Cameras, Images and Files, and Methods of Using, Operating, Processing and Viewing Same” (Atty. Docket No. LYT3006), filed on Feb. 15, 2011, the disclosure of which is incorporated herein by reference.

### FIELD OF THE INVENTION

The present invention relates to storage, manipulation, and/or transmission of image data and related data.

### BACKGROUND

Light field photography captures information about the direction of light as it arrives at a sensor within a data acquisition device such as a light field camera. Such light field data can be used to create representations of scenes that can be manipulated by a user. Subsequent to image capture, light field processing can be used to generate images using the light field data. Various types of light field processing can be performed, including for example refocusing, aberration correction, 3D viewing, parallax shifting, changing the viewpoint, and the like. These and other techniques are described in the related U.S. Utility Applications referenced above.

Conventionally, images may be represented as digital data that can be stored electronically. Many such image formats are known in the art, such as for example JPG, EXIF, BMP, PNG, PDF, TIFF and/or HD Photo data formats. Such image formats can be used for storing, manipulating, displaying, and/or transmitting image data.

Different devices may have different attributes, including capabilities, limitations, characteristics, and/or features for displaying, storing, and/or controlling images. Such differences may include, for example, screen sizes, three-dimensional vs. two-dimensional capability, input mechanisms, processing power, storage space, graphics processing units (or lack thereof), and the like. Such differences in attributes can be based on device hardware, software, bandwidth limitations, user preferences, and/or any other factors. In addition, in different contexts, it may be desirable to provide different types of capabilities and features for viewing and/or controlling images. Furthermore, for different applications and contexts, it may be useful or desirable to provide different image sizes.

Existing techniques for storing, transmitting, and distributing images often fail to take into account such differences in device attributes and desired features. In some cases, failing to take such considerations into account can result in excessive use of bandwidth, processing power, storage space, and/or other resources; in other cases, it can result in a device being unable to properly render or display an image using the data supplied to it.

For example, a device with a small, relatively low-resolution screen (such as a cellular telephone) may not be capable of displaying images at the same resolution as a large high-definition television. Sending a full-resolution image to the cellular telephone wastes valuable bandwidth and storage space; conversely, sending a low-resolution image to the high-definition television results in poor quality output. As another example, sending data for controlling an image using, for example, an accelerometer, is a waste of bandwidth if the target device does not have an accelerometer. As yet another example, sending data that is used in refocusing operations to a device that does not have such refocusing capability is another example of wasted resources.

Because of these limitations, existing techniques for transmitting, distributing, and/or storing image data, such as light field image data, are unable to efficiently use resources while maximizing performance and minimizing waste of resources.

### SUMMARY

According to various embodiments of the invention, a system and method are provided for storing, manipulating, and/or transmitting image data, such as light field photographs and the like, in a manner that efficiently delivers different capabilities and features based on device attributes, user requirements and preferences, context, and/or other factors.

In at least one embodiment, the techniques of the present invention are implemented by providing supplemental information in data structures for storing frames and pictures as described in related U.S. Utility Application Serial No. 13/155,882 for “Storage and Transmission of Pictures Including Multiple Frames,” (Atty. Docket No. LYT009), filed Jun. 8, 2011, the disclosure of which is incorporated herein by reference. Such supplemental information is used for accelerating, or optimizing, the process of generating, storing, and/or transmitting image data; accordingly, in the context of the present invention, the data structures for storing the supplemental information are referred to as “acceleration structures”.

As described in the related application, a container file representing a scene (referred to herein as a “picture” or “picture file”) can include or be associated with any number of component image elements (referred to herein as “frames”). Frames may come from different image capture devices, enabling aggregation of image data from multiple sources. Frames can include image data as well as additional data describing the scene, its particular characteristics, image capture equipment, and/or the conditions under which the frames were captured. Such additional data are referred to as metadata, which may be universal or application-specific. Metadata may include, for example, tags, edit lists, and/or any other information that may affect the way images derived from the picture look. Metadata may further include any other state information that is or may be associated with a frame or picture and is visible to an application. Picture files may also include instructions for combining frames and performing other operations on frames when rendering a final image.

In at least one embodiment, the data structures for implementing frames and pictures are supplemented with acceleration structures to enable selective use of certain types of data (also referred to as “assets”) based on device attributes such as image size, desired functionality, user preference, and/or the like. In this manner, the system and method of the present invention takes into account specific attributes and parameters in determining which data should be included.

For example, depending on the particular scenario, the assets can include a complete description of the light field image, so as to allow refocusing and/or other capabilities associated with light field data; alternatively, the assets may include a set of two-dimensional images that can provide more limited refocusing capability than the complete light field data. The determination of which type of asset or assets to provide can be made based on any suitable factor or set of factors, including for example device attributes, desired features, and the like. In at least one embodiment, efficiency is maximized by transmitting those assets having minimal size or impact on resource consumption, while still delivering the desired functionality.

In at least one embodiment, the system of the present invention includes mechanisms for displaying a final image at an output device, based on transmitted, stored, and/or received assets. These assets may include any number of frames, as described in the above-referenced application, as well as descriptions of operations that are to be performed on the frames.

Accordingly, in various embodiments, the system of the present invention provides a mechanism by which transmission, storage, and/or rendering of image data, including light field data is optimized so as to improve efficiency and avoid waste of resources.

The present invention also provides additional advantages, as will be made apparent in the description provided herein.

One skilled in the art will recognize that the techniques for storing, manipulating, and transmitting image data, including light field data, described herein can be applied to other scenarios and conditions, and are not limited to the specific examples discussed herein. For example, the techniques are not limited to light field pictures, but can also be applied to images taken by conventional cameras and other imaging devices, whether or not such images are represented as light field data.

### BRIEF DESCRIPTION OF THE DRAWINGS

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention.

FIG. 1A depicts an architecture for implementing the present invention in a client/server environment, according to one embodiment.

FIG. 1B depicts an architecture for a device for operation in connection with the present invention, according to one embodiment.

FIG. 1C depicts an architecture for implementing the present invention in a client/server environment, according to one embodiment.

FIG. 2 depicts an architecture for implementing the present invention in connection with multiple devices having different attributes, according to one embodiment.

FIG. 3 depicts an example of an implementation of the present invention, showing exemplary attributes for different devices, according to one embodiment.

FIG. 4 is an event trace diagram depicting a method for requesting and receiving image assets tailored to device attributes, according to one embodiment.

FIG. 5A depicts an example of a conceptual architecture for a focus stack containing multiple images and stored in a data storage device, according to one embodiment.

FIG. 5B depicts an example of a conceptual architecture for a focus stack containing multiple image tiles and stored in a data storage device, according to one embodiment.

FIGS. 6A through 6E depict a series of examples of images associated with different focal lengths and stored in a focus stack, according to one embodiment.

FIGS. 7A through 7E depict a series of examples of possible tilings of the images depicted in FIGS. 6A through 6E, according to one embodiment.

FIGS. 8A through 8E depict the tilings of FIGS. 7A through 7E, with the images removed for clarity.

FIG. 9 is a flow diagram depicting a method of generating an image from tiles of a focus stack, according to one embodiment.

FIG. 10 depicts an example of a relationship among light field picture files, pictures and frames, according to one embodiment.

FIG. 11 depicts an example of a data structure for a light field picture file, according to one embodiment.

### DETAILED DESCRIPTION OF THE EMBODIMENTS

### Terminology

The following terms are defined for purposes of the description provided herein:
Frame: a data entity (stored, for example, in a file) containing a description of the state corresponding to a single captured sensor exposure in a camera. This state includes the sensor image, and other relevant camera parameters, specified as metadata. The sensor image may be either a raw image or a compressed representation of the raw image.
Picture: a data entity (stored, for example, in a file) containing one or more frames, metadata, and/or data derived from the frames and/or metadata. Metadata can include tags, edit lists, and/or any other descriptive information or state associated with a picture or frame.
Light field: a collection of rays. A ray's direction specifies a path taken by light, and its color specifies the radiance of light following that path.
Light field image: a two-dimensional image that spatially encodes a four-dimensional light field. The sensor image from a light field camera is a light field image.
Light field picture: a picture with one or more light field frames. (A picture with a mix of two-dimensional and light field frames is a light field picture.)
LFP file: A file containing one or more frame(s) and/or picture(s).
Microlens: a small lens, typically one in an array of similar microlenses.
Pixel: an n-tuple of intensity values, with an implied meaning for each value. A typical 3-tuple pixel format is RGB, wherein the first value is red intensity, the second green intensity, and the third blue intensity. Also refers to an individual sensor element for capturing data.
Sensor image: any representation of a raw image.
Two dimensional (2D) image (or image): a two-dimensional (2D) array of pixels. The pixels are typically arranged in a square or rectangular Cartesian pattern, but other patterns are possible.
Two dimensional (2D) picture: a picture that includes only 2D frames.
Device: any electronic device capable of capturing, processing, transmitting, receiving, and/or displaying image data.
Refocused image: a 2D image that has been generated from a light field image.
Focus Stack: a collection of refocused images and/or 2D images, possibly of the same or similar scene at different focus depths.
Tile: a portion of a refocused or 2D image.
Tiled Focus Stack: a collection of tiles, possibly representing portions of the same or similar scene at different focus depths.
Extended Depth of Field (EDOF) image: an image having an extended depth of field.
Sub-aperture image (SAI): a low-resolution view of a scene taken from a given position, generated by taking a sample from the same relative position under each microlens.
Depth map: a mapping of focus depth to points within an image; specifies a depth value (indicating focus depth) for each point (or for some set of points) in an image.
Asset: any data that can be used for rendering an image, picture, or frame. May include, for example and without limitation, light field image(s) and/or picture(s), focus stack, tiled focus stack, EDOF image(s), sub-aperture image(s), depth map(s), and/or any combination thereof.

In addition, for ease of nomenclature, the term “camera” is used herein to refer to an image capture device or other data acquisition device. Such a data acquisition device can be any device or system for acquiring, recording, measuring, estimating, determining and/or computing data representative of a scene, including but not limited to two-dimensional image data, three-dimensional image data, and/or light field data. Such a data acquisition device may include optics, sensors, and image processing electronics for acquiring data representative of a scene, using techniques that are well known in the art. One skilled in the art will recognize that many types of data acquisition devices can be used in connection with the present invention, and that the invention is not limited to cameras. Thus, the use of the term “camera” herein is intended to be illustrative and exemplary, but should not be considered to limit the scope of the invention. Specifically, any use of such term herein should be considered to refer to any suitable data acquisition device.

### System Architecture

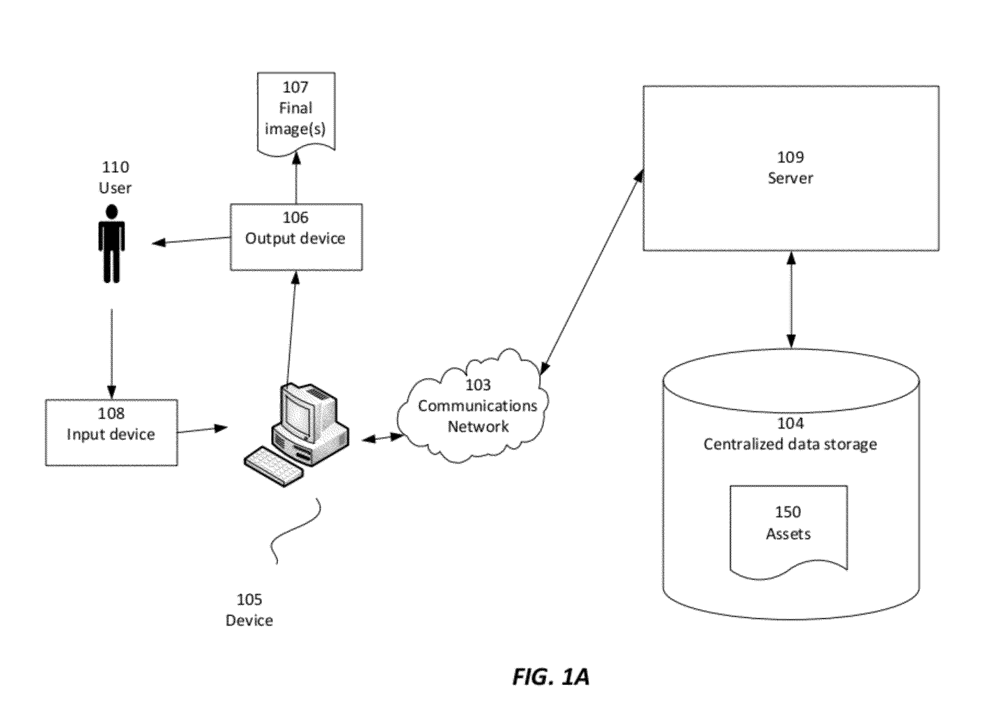

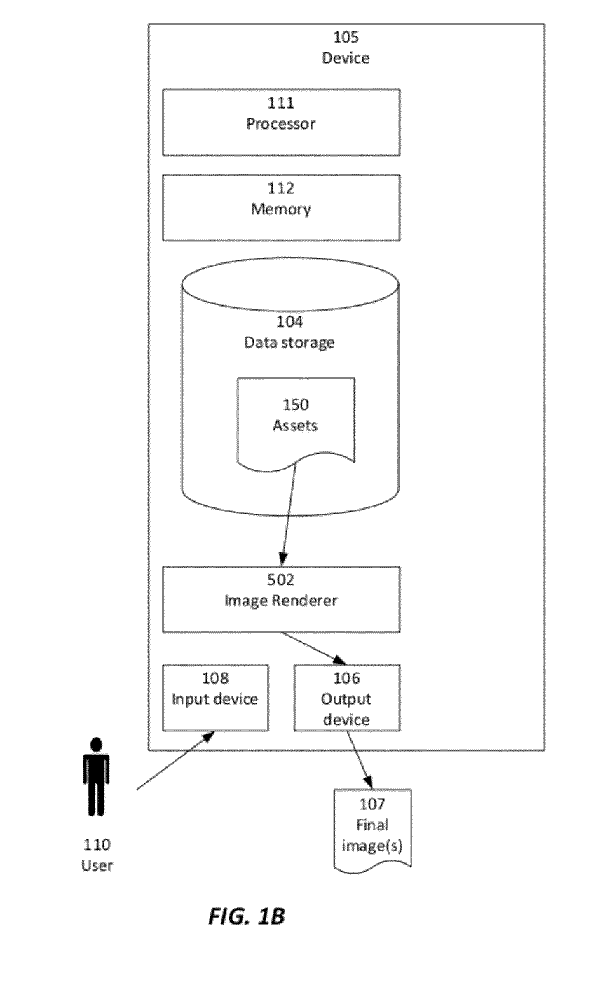

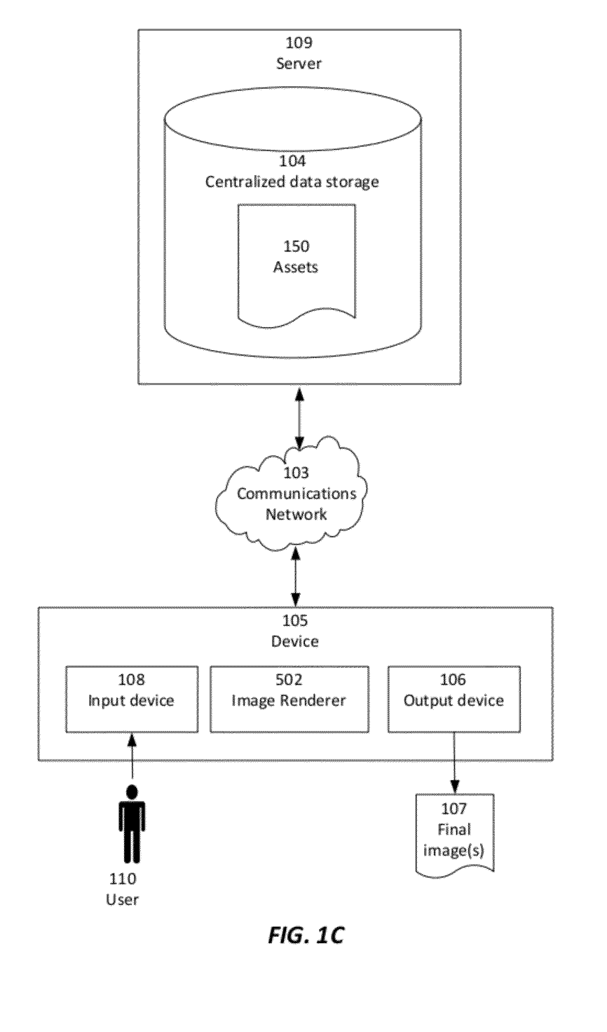

Referring now to FIG. 1A, there is shown an architecture for implementing the present invention in a client/server environment according to one embodiment. Device 105 can be any electronic device capable of capturing, processing, transmitting, and/or receiving image data. For example, device 105 may be any electronic device having output device 106 (such as a screen) on which user 110 can view an image. Device 105 may be, for example and without limitation, a desktop computer, laptop computer, personal digital assistant (PDA), cellular telephone, smartphone, music player, handheld computer, tablet computer, kiosk, game system, enterprise computing system, server computer, or the like. In at least one embodiment, device 105 runs an operating system such as for example: Linux; Microsoft Windows, available from Microsoft Corporation of Redmond, Wash.; Mac OS X, available from Apple Inc. of Cupertino, Calif.; iOS, available from Apple Inc. of Cupertino, Calif.; and/or any other operating system that is adapted for use on such devices.

In at least one embodiment, user 110 interacts with device 105 via input device 108, which may include physical button(s), touchscreen, rocker switch, dial, knob, graphical user interface, mouse, trackpad, trackball, touch-sensitive screen, touch-sensitive surface, keyboard, and/or any combination thereof. Device 105 may operate under the control of software.

In at least one embodiment, device 105 is communicatively coupled with server 109, which may be remotely located with respect to device 105, via communications network 103. Image data and/or metadata (collectively referred to as assets 150) are stored in storage device 104 associated with server 109. Data storage 104 may be implemented as any magnetic, optical, and/or electrical storage device for storage of data in digital form, such as flash memory, magnetic hard drive, CD-ROM, and/or the like.

Device 105 makes requests of server 109 in order to retrieve assets from storage 104 via communications network 103 according to known network communication techniques and protocols. Communications network 103 can be any suitable network, such as the Internet. In such an embodiment, assets 150 can be transmitted to device 105 using HTTP and/or any other suitable data transfer protocol.

As described in more detail below, device 105 and/or the software running on it may have certain attributes, including limitations, capabilities, characteristics, and/or features that may be relevant to the manner in which images are to be displayed thereon. In addition, in at least one embodiment, certain parameters configured by user 110 or by another entity may specify which features and/or characteristics are desired for images to be output images; for example, such an individual may specify that images should be shown in three dimensions, or having refocus capability, or the like. As will be described in more detail below, specific characteristics of output images may depend on device limitations, software limitations, user preferences, administrator preferences, bandwidth, context, and/or any other relevant factor(s). The techniques of the present invention provide mechanisms for providing the appropriate assets to efficiently generate and display images 107 at output device 106 associated with device 105.

One skilled in the art will recognize that the architecture depicted in FIG. 1A is merely exemplary, and that the techniques of the present invention can be implemented using other architectures, components, and arrangements. For example, in an alternative embodiment, the techniques of the present invention can be implemented in a stand-alone electronic device, wherein assets are stored locally. In such an embodiment, the techniques described herein are used for determining which assets to retrieve from local storage in order to render an image based on limitations and/or characteristics of the device, desired features, and/or any combination thereof.

In various embodiments, assets 150 represent image data for light field images. As described in more detail in the above-referenced applications, such data can be organized in terms of pictures and frames, with each picture having any number of frames. As described in the above-referenced applications, frames may represent individual capture events that took place at one or several image capture devices, and that are combinable to generate a picture. Such a relationship and data structure are merely exemplary, however; the techniques of the present invention can be implemented in connection with image data having other formats and arrangements. In other embodiments, assets 150 can represent image data derived from light field images, or may represent conventional non-light field image data.

Input device 108 receives input from user 110; such input may include commands for displaying, editing, deleting, transmitting, combining, and/or otherwise manipulating images. In at least one embodiment, such input may specify characteristics and/or features for the display of images, and such characteristics and/or features can, at least in part, determine which asset(s) 150 are to be requested from server 109.

In at least one embodiment, based on instructions received from user 110, device 105 retrieves assets 150, and renders and displays final image(s) 107 using the retrieved assets 150.

Referring now to FIG. 1B, there is shown an architecture for device 105 for operation in connection with the present invention, according to one embodiment. User 110 interacts with device 105 via input device 108, which may include a mouse, trackpad, trackball, keyboard, and/or any of the other input components mentioned above. User 110 views output, such as final image(s) 107, on output device 106 which may be, for example, a display screen.

Device 105 may be any electronic device, including for example and without limitation, a desktop computer, laptop computer, personal digital assistant (PDA), cellular telephone, smartphone, music player, handheld computer, tablet computer, kiosk, game system, enterprise computing system, server computer, or the like. In at least one embodiment, device 105 runs an operating system such as for example: Linux; Microsoft Windows, available from Microsoft Corporation of Redmond, Wash.; Mac OS X, available from Apple Inc. of Cupertino, Calif.; iOS, available from Apple Inc. of Cupertino, Calif.; and/or any other operating system that is adapted for use on such devices.

Device 105 stores assets 150 (which may include image data, pictures, and/or frames as described in the related applications) in data storage 104. Data storage 104 may be located locally or remotely with respect to device 105. Data storage 104 may be implemented as any magnetic, optical, and/or electrical storage device for storage of data in digital form, such as flash memory, magnetic hard drive, CD-ROM, and/or the like. Data storage 104 can also be implemented remotely, for example at a server (not shown in FIG. 1B).

In at least one embodiment, device 105 includes a number of hardware components as are well known to those skilled in the art. In addition to data storage 104, input device 108 and output device 106, device 105 may include, for example, one or more processors 111 (which can be a conventional microprocessor for performing operations on data under the direction of software, according to well-known techniques) and memory 112 (such as random-access memory having a structure and architecture as are known in the art, for use by the one or more processors in the course of running software). Such components are well known in the art of computing architecture.

Referring now to FIG. 1C, there is shown an alternative architecture for implementing the present invention in a client/server environment, according to one embodiment. In this architecture, assets 150 (which may include image data, pictures, and/or frames as described in the related applications) are stored in centralized data storage 104 at a server 109, which may be located remotely with respect to device 105. Assets 150 are transmitted to device 105 via any suitable mechanism; one example is communications network 103 such as the Internet. In such an embodiment, assets 150 can be transmitted using HTTP and/or any other suitable data transfer protocol. Client device 105 is communicatively coupled with server 109 via communications network 103.

User 110 interacts with device 105 via input device 108, which may include a mouse, trackpad, trackball, keyboard, and/or any of the other input components mentioned above. Under the direction of input device 108, device 105 transmits a request to cause data (including some or all assets 150) to be transmitted from server 109 to device 105. Image renderer 502 processes assets 150 to generate final image(s) 107 for display at output device 106. Although image renderer 502 is depicted in FIG. 1C as being located at device 105, one skilled in the art will recognize that image renderer 502 can instead be located at server 109 or at any other suitable location in the system.

In at least one embodiment, device 105 includes a network interface (not shown) for enabling communication via network 103, and may also include browser software (not shown) for transmitting requests to server 109 and receiving responses therefrom.

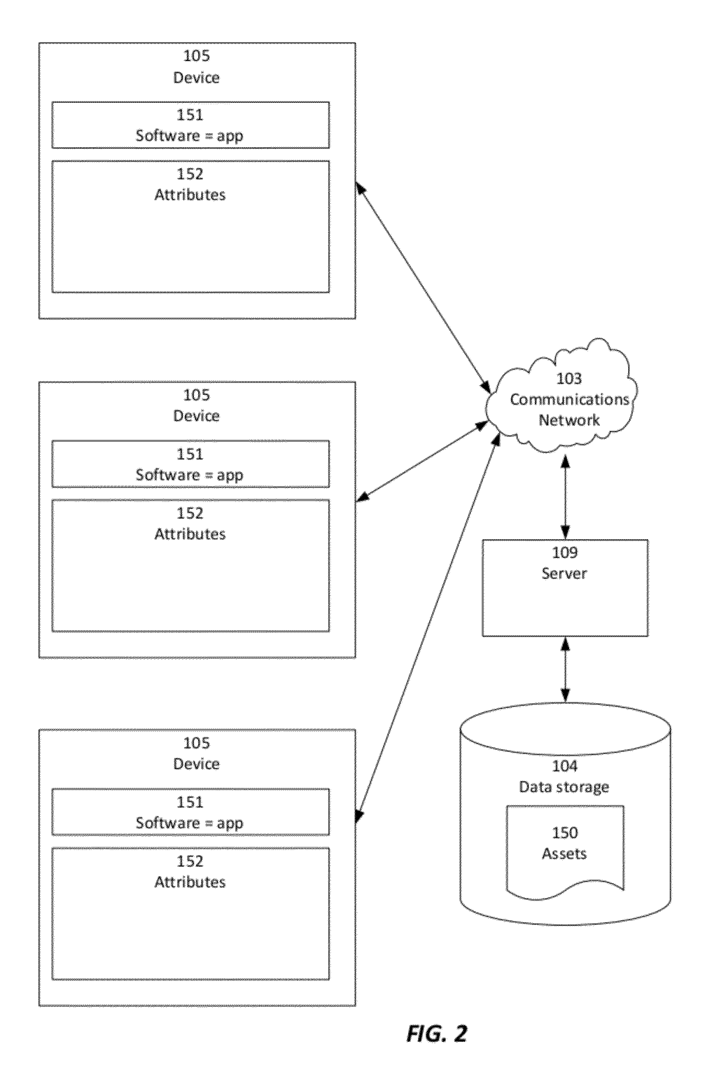

In at least one embodiment, any number of devices 105 can communicate with server 109 via communications network 103 to both transmit and/or receive assets 150 to/from server 109. Such devices 105 may have different attributes. In addition, different features may be desired for particular imaging operations in different contexts. Referring now to FIG. 2, there is shown an architecture for implementing the present invention in connection with multiple devices having different attributes, according to one embodiment.

In the example of FIG. 2, three devices 105 are shown, although any number of devices 105 can be included. Each device 105 in the example runs software 151, such as an app (application). The combination of the characteristics of the device 105 and its software 151, along with the desired operations, dictates certain attributes 152 relevant to image processing and/or display to take place in connection with device 105. These attributes 152 can differ from device 105 to device 105; accordingly, the system and method of the present invention provide techniques for tailoring the particular subset of assets 150 transmitted to each device 105 according to its particular attributes 152.

Table 1 shows examples of attributes 152 that may apply to devices 105, singly or in any suitable combination with one another. For each attribute 152, the particular assets 150 that may be provided to device 105 can differ depending on whether the attribute 152 is present and/or based on particular characteristics of device 105 defined by that attribute 152. One skilled in the art will recognize that this list merely presents examples and is not intended to be limiting in any manner:

TABLE 1

| Attribute | | | Example of effect on assets |
|---|---|---|---|
| Type | Name | Description | provided to device |
| Feature | Refocusing | The ability to refocus an | Determines whether to provide |
| | | image at any of a | image data for different focus |
| | | number of different | depths |
| | | focus depths | |
| Feature | 3D/stereo | The ability to present an | Determines whether to provide 3D |
| | | image in a 3D format by | stereo data |
| | | offering stereoscopic | |
| | | vision | |
| Feature | 3D/parallax | The ability to present a | Determines whether to provide |
| | | parallax shift | data for different points of view |
| | | resembling a 3D | |
| | | presentation | |
| Feature | Extended Depth | The ability to present an | Determines whether to provide |
| | of Field (EDOF) | image in manner that | EDOF data |
| | | preserves relatively | |
| | | sharp focus for a wide | |
| | | range of focus depths | |
| Feature | Depth-based | The ability to process | Determines whether to provide |
| | processing | different portions of the | depth information |
| | | image differently | |
| | | depending on the | |
| | | depicted distance from | |
| | | the viewer | |
| Feature | Slideshow | The ability to display | Determines whether to provide any |
| | | animations or | information about slideshows or |
| | | sequences of images | other animations, including assets |
| | | over time | for slideshow transition effects, and |
| | | | the like |
| Feature | User | The ability of the user to | Determines whether the data |
| | annotations | add, modify, or remove | provided may include links, |
| | | information associated | functions, commands, or other |
| | | with the image, | mechanisms for the user to add, |
| | | including (for example) | modify, or delete such image |
| | | tags, annotations, | information such that the changes |
| | | comments, titles, and | are published, shared, or otherwise |
| | | the like | made visible to other users viewing |
| | | | the images |
| Feature | Editing | The ability of the user to | Determines whether to provide |
| | | edit the images, for | data enabling edits to images |
| | | example by changing | |
| | | contrast, white balance, | |
| | | sharpness, hue, tint, | |
| | | saturation, brightness, | |
| | | or any other image | |
| | | characteristic | |
| Image | Image size | Small vs. large | More detailed data may be |
| characteristic | | | provided for larger images |
| Image | Image size | Specific pixel count | More detailed data may be |
| characteristic | | and/or resolution | provided for larger images |
| Device | 3D screen | Indicates whether or not | Determines whether to provide 3D |
| characteristic | | the device has a 3D | data |
| | | screen | |
| Device | Accelerometer | Indicates whether the | Determines whether to provide |
| characteristic | | device includes an | information determining how image |
| | | accelerometer that can | responds to movement of the |
| | | be used for interacting | device |
| | | with images | |
| Device | Graphics | Indicates whether or not | Determines whether to provide |
| characteristic | Processing Unit | the device includes a | additional data that can be used by |
| | (GPU) | GPU that can be used | a GPU |
| | | to accelerate rendering | |
| | | of images | |
| Device | Screen size | Specifies the physical | Lower levels of rendering |
| characteristic | | size of the device's | resolution may be provided for |
| | | screen | smaller screens |
| Device | Software | Specifies the type of | Determines the type of data to be |
| characteristic | | software being used for | provided to render images using |
| | | viewing images | the specified software |

For purposes of the present invention, device 105 can be a physical device (such as a computer, camera, smartphone, or the like), or it can be a software application. For example, a computer may be running several different software applications for viewing images, each of which has different attributes; one may provide refocusing capability, while another provides parallax viewing, and yet another provides 3D stereo viewing. For purposes of the present invention, each such application might be considered a distinct “device” 105, in the sense that, depending on which application is active, different assets 150 might be needed to enable the desired functionality.

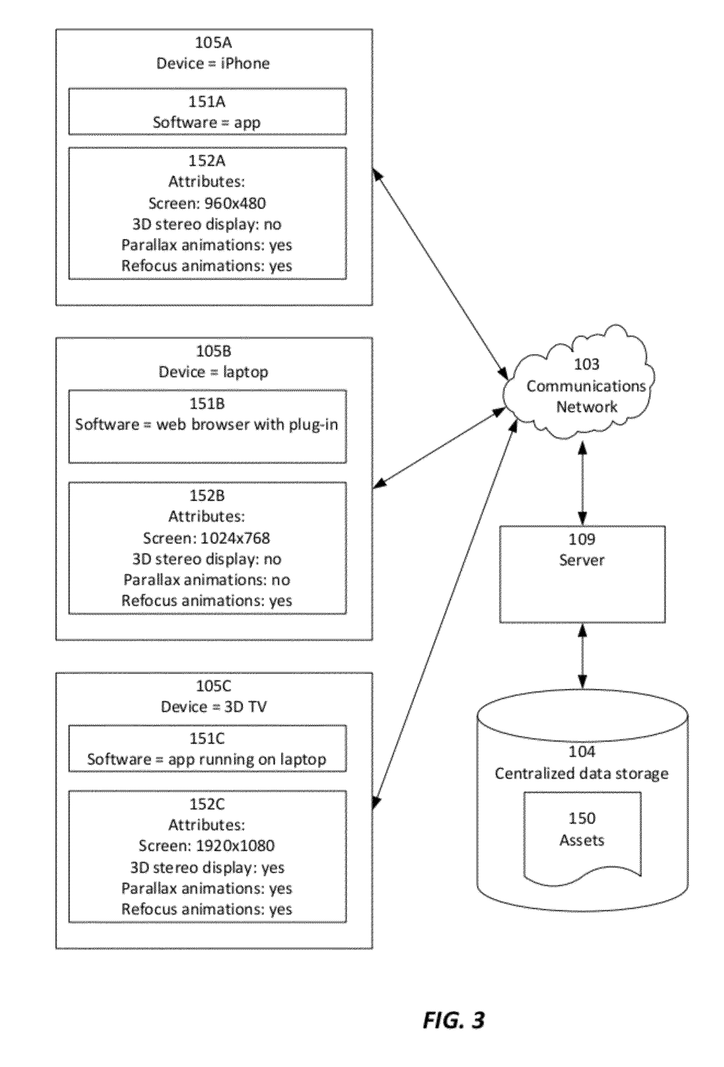

Referring now to FIG. 3, there is shown an example of an implementation of the present invention, depicting exemplary attributes for different devices, according to one embodiment. In this example, three devices 105 are depicted, each having different attributes.

Device 105A is an iPhone running an app 151A through which images will be viewed. The particular attributes 152A for image presentation on device 105A are shown in FIG. 3: a 960×480 pixel screen, no 3D stereo display, but with parallax animations and refocus animations.

Device 105B is a laptop computer running a web browser including a plug-in 151B through which images will be viewed. The particular attributes 152B for image presentation on device 105B are shown in FIG. 3: a 1024×768 pixel screen, no 3D stereo display, no parallax animations, but with refocus animations.

Device 105C is a 3D television controlled by an app 151C running on a laptop. The particular attributes 152C for image presentation on device 105C are shown in FIG. 3: a 1920×1080 pixel screen including 3D stereo display, parallax animations, and refocus animations.

According to the techniques of the present invention, different image data, including subsets of available assets 150 are provided to each of devices 105A, 105B, 105C based on particular attributes of each device.

One skilled in the art will recognize that variations on this architecture can be used. For example, either of the following variations can be implemented:
Device 105 can specify attributes and desired features in a request transmitted to server 109; server 109 makes a determination of which assets 150 are needed, and responds with links to those assets 150;
Device 105 queries server 109 for links to all available assets 150; device 105 then requests those assets that are needed for the attributes and desired features;

In either case, server 109 can retrieve assets 150 that have been previously generated and/or captured, or it can generate assets 150 on demand. For example, if a full light field image is available at centralized data storage 104 but is deemed unsuitable for a particular request received from a device 105, server 109 can generate suitable assets 150 on-the-fly from the stored light field image, if such suitable assets 150 are not already available.

In at least one other embodiment, assets 150 can be generated locally rather than at server 109. For example, device 105 itself may generate assets 150; alternatively, the image capture device may generate assets at the time of image capture or at some later time. In at least one embodiment, device 105 (and/or image capture device) can determine which assets 150 to generate based on particular device characteristics and/or features to be enabled. The appropriate assets 150, once generated, can be stored locally and/or can be provided to server 109 for storage at centralized data storage 104.

### Method

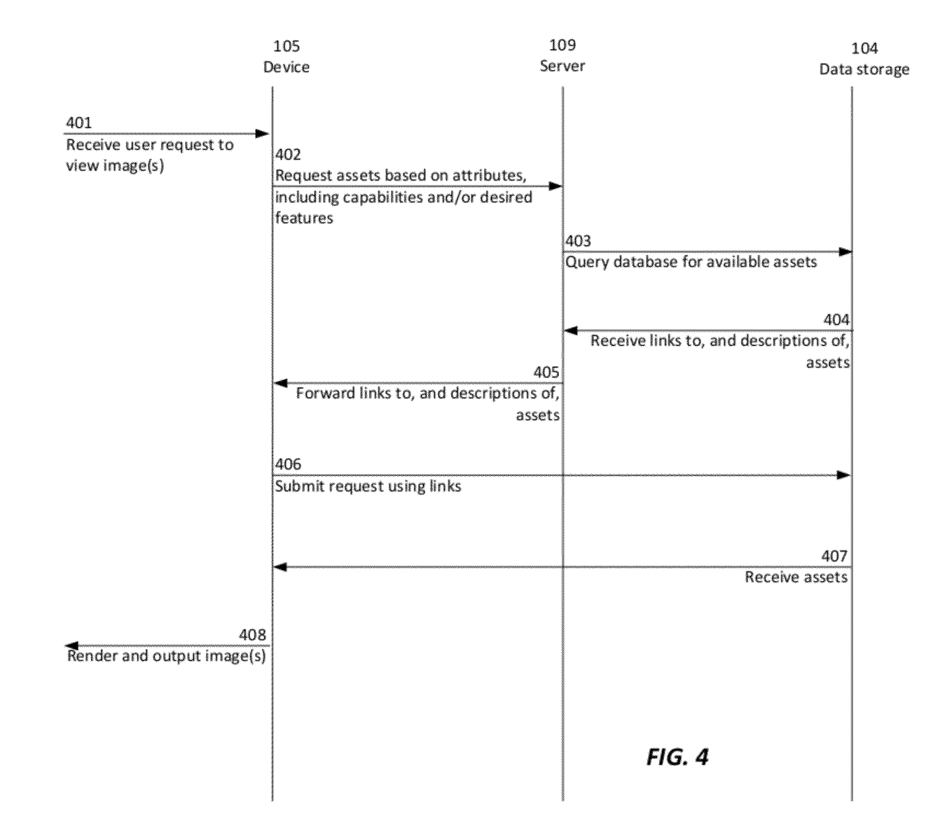

Referring now to FIG. 4, there is shown an event trace diagram depicting a method for requesting and receiving image assets tailored to device attributes, according to at least one embodiment.

Device 105 receives 401 a user request to view one or more image(s). Such request can be provided, for example, via input provided at input device 108. For example, user 110 may navigate to an image within an album, or may retrieve an image from a website, or the like. In at least one embodiment, the techniques of the present invention can be applied to images that are presented automatically and without an explicit user request; for example, in response to an incoming phone call wherein it may be desired to show a picture of the caller, or in response to automatic activation of a screen saver for depicting images.

Device 105 requests 402 assets 150 from server 109. The specific assets 150 requested can be based on determined attributes, including capabilities, features, and/or characteristics of device 105, software 151 running on device 105, context of the image display request, and/or any other factors. In at least one embodiment, device 105 determines which assets 150 to request, and makes the appropriate request 402. In at least one other embodiment, device 105 sends information to server 109 regarding attributes (including device capabilities and/or desired features of the image display), and server 109 makes a determination from such information as to what assets 150 to provide.

In at least one embodiment, server 109 queries 403 a database, such as one stored at data storage 104, to determine what assets 150 are available based on request 402. Server 109 receives 404, from database, links to and descriptions of available assets 150, and forwards 405 such information to device 105. In at least one embodiment, the transmission 405 to device 105 includes links to those particular assets 150 that are well-suited to the quest 402, based on the specified attributes. In another embodiment, transmission 405 includes links to all assets 150 available at storage 104, so that device 105 determines which assets 150 to request. Device 105 then submits 406 a request to data storage 104 to obtain assets 150 using the information received from server 109. Data storage 104 responds 407 with the assets 150, which are received at device 105. Device 105 then renders and outputs 408 image(s) 107 on output device 106, using assets 150 received from data storage 104.

In at least one other embodiment, server 109 obtains assets 150 from data storage 104 based on the attributes specified in request 402, and transmits such assets 150 from server 109 to device 105. Such an implementation may be preferable, in some situations, rather than having device 105 request data directly from data storage 104 as depicted in FIG. 4.

### Data Structures

In at least one embodiment, assets 150 can be stored and/or transmitted using an enhancement of the data structures described in related U.S. Utility Application Serial No. 13/155,882 for “Storage and Transmission of Pictures Including Multiple Frames,” (Atty. Docket No. LYT009), filed Jun. 8, 2011, the disclosure of which is incorporated herein by reference.

In at least one embodiment, assets 150 are provided in files, referred to as light field picture (LFP) files, stored at data storage 104. Image data is organized within LFP files as pictures and frames, along with other data.

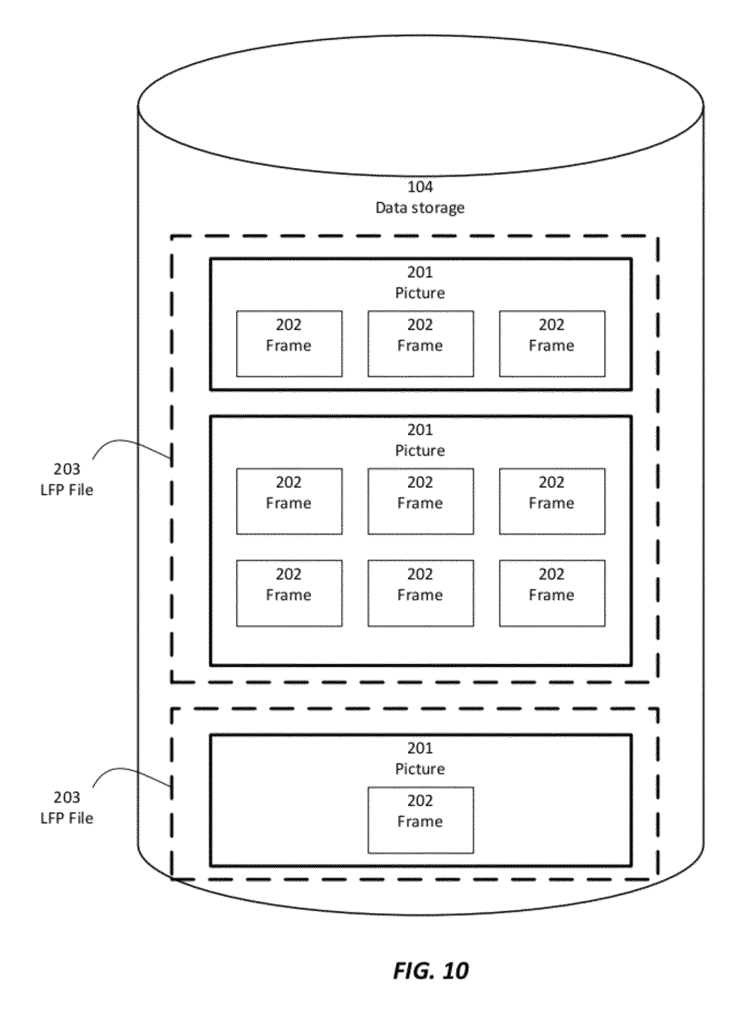

Referring now to FIG. 10, there is shown an example of a relationship among LFP files 203, pictures 201, and frames 202, according to at least one embodiment. Each LFP file 203 can contain any number of pictures 201, including any suitable combination of assets 150, as described in more detail below. In the example of FIG. 10, one LFP file 203 contains two pictures 201, and another contains one picture 201.

Frames 202 can be generated by cameras 100 and/or other visual data acquisition devices; each frame 202 includes data related to an individual image element such as an image captured by a camera 100 or other visual data acquisition device. Any number of frames 202 can be combined to form a picture 201. For example a picture 201 may include frames 202 captured by different cameras 100 either simultaneously or in succession, and/or may include frames 202 captured by a single camera 100 in succession. Frames 202 may be captured as part of a single capture event or as part of multiple capture events. Pictures 201 may include any type of frames 202, in any combination including for example two-dimensional frames 202, light field frames 202, and the like. A picture 201 with one or more light field frames 202 is referred to as a light field picture.

In at least one embodiment, each frame 202 includes data representing an image detected by the sensor of the camera (image data), and may also include data describing other relevant camera parameters (metadata), such as for example, camera settings such as zoom and exposure time, the geometry of a microlens array used in capturing a light field frame, and the like. The image data contained in each frame 202 may be provided in any suitable format, such as for example a raw image or a lossy compression of the raw image, such as for example, a file in JPG, EXIF, BMP, PNG, PDF, TIFF and/or HD Photo format. The metadata may be provided in text format, XML, or in any other suitable format. As described in more detail herein, frames 202 may include the complete light field description of a scene, or some other representation better suited to the attributes associated with the device and/or software with which the image is to be displayed.

For illustrative purposes, in FIG. 10, frames 202 are shown as being enclosed by pictures 201. However, one skilled in the art will recognize that such a representation is conceptual only. In fact, in at least one embodiment, pictures 201 are related to their constituent frame(s) 202 by virtue of pointers in LFP files 203 and/or in database records. In at least one embodiment, any particular frame 202 can be a constituent of any number of pictures 201, depending on how many pictures 201 contain a pointer to that frame 202. Similarly, any particular picture 201 can contain any number of frames 202, depending on how many frames 202 are identified as its constituents in its database record. In another embodiment, picture 201 may be a container file that actually contains frame(s) 202. In general, references herein to a picture 201 “containing” one or more frames 202 mean that those frames 202 are associated with picture 201.

In at least one embodiment, if a frame 202 appears in more than one picture 201, it need only be stored once. Pointers are stored to establish relationships between the frame 202 and the various pictures 201 it corresponds to. Furthermore, if frame 202 data is not available, frame 202 can be represented by its corresponding digest 402, as described herein.

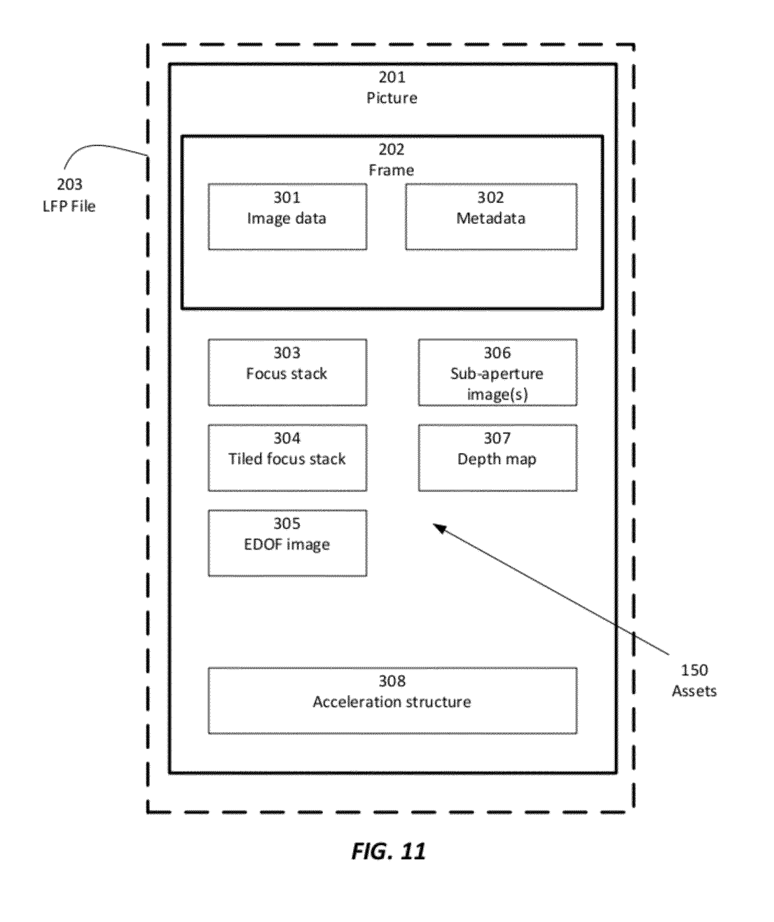

Referring now to FIG. 11, there is shown an example of a data structure for an LFP file 203 according to one embodiment. In this example, LFP file 203 contains a single picture 201, although one skilled in the art will recognize that an LFP file 203 can contain any number of pictures 201. In this example, picture 201 includes a number of assets 150, along with an acceleration structure 308 defining different ways in which assets 150 can be used to generate final images 107. Although FIG. 11 depicts acceleration structure 308 as a distinct component within picture 201, one skilled in the art will recognize that other arrangements are possible; for example, in at least one embodiment, acceleration structure 308 can include some or all of assets 150.

Assets 150 include any or all of frame(s) 202 (having image data 301 and metadata 302), focus stack 303, tiled focus stack 304, extended depth-of-field (EDOF) image 305, sub-aperture image(s) 306, and depth map 307. Although the example depicts all of these assets 150 in a single LFP file 203, one skilled in the art will recognize that any suitable subset of such assets 150 can be included; in fact, it is not necessary for all of the assets 150 to be included within a single LFP file 203 to practice the present invention. Rather, those assets 150 suitable for use according to acceleration structure 308 may be provided, and other assets 150 may be omitted. Also, one skilled in the art will recognize that the particular assets 150 depicted in FIG. 11 are merely exemplary, and that other types of assets 150 can be provided, singly or in combination, according to the particular attributes of the system and its components.

Image Data 301

In at least one embodiment, frame 202 includes image data 301 and/or metadata 302, although some frames 202 may omit one or the other. In various embodiments, frames 202 can include image data 301 for two-dimensional and/or light field sensor images. In other embodiments, other types of image data 301 can be included in frames 202, such as three-dimensional image data and the like. In at least one embodiment, a depth map of the scene is extracted from the light field, so that three-dimensional scene data can be obtained and used. In another embodiment, a camera can capture a two-dimensional image, and use a range finder to capture a depth map; such captured information can be stored as frame data, so that the two-dimensional image and the depth map together form a three-dimensional image.

Metadata 302

In at least one embodiment, metadata 302 includes fields for various parameters associated with image data 301, such as for example camera settings such as zoom and exposure time, the geometry of a microlens array used in capturing a light field frame, and the like.

In at least one embodiment, metadata 302 may include identifying data, such as a serial number of the camera or other device used to capture the image, an identifier of the individual photographer operating the camera, the location where the image was captured, and/or the like. Metadata 302 can be provided in any appropriate format, such as for example a human-readable text file including name-value pairs. In at least one embodiment, metadata 302 is represented using name-value pairs in JavaScript Object Notation (JSON). In at least one embodiment, metadata 302 is editable by user 110 or any other individual having access to frame 202. In at least one embodiment, metadata 302 is provided in XML or text format, so that any text editor can be used for such editing.

Focus Stack 303

Focus stack 303 includes a collection of refocused images at different focus depths. In general, providing a focus stack 303 can reduce the amount of storage space and/or bandwidth required, as the focus stack 303 can take less space than the light field data itself. Images in the focus stack 303 can be generated by projection of the light field data at various focus depths. The more images that are provided within a focus stack 303, the smoother the animation when refocusing at device 105, and/or the greater the range of available focus depths. In at least one embodiment, when a focus stack 303 is included as an asset 150 within LFP file 203, acceleration structure 308 defines focus stack 303 and provides metadata describing images within focus stack 303 (for example to specify depth values for images within focus stack 303). In at least one embodiment, each image in focus stack 303 depicts the entire scene.

Tiled Focus Stack 304

Tiled focus stack 304 includes a collection of tiles which represent portions of refocused images at different focus depths. Each tile within tiled focus stack 304 depicts a portion of the scene. By avoiding the need to represent the entire scene at each focus depth, storage space and/or bandwidth can be conserved. For example, if an image has a foreground and a background, rather than storing several images depicting the entire scene at different focus depths, tiles can be stored wherein only the foreground is stored at different focus depths, and other tiles can store the background at different focus depths. These tiles can then be blended and/or stitched together to achieve a desired effect and focus depth. In another embodiment, tiles can be stored with only the in-focus portion of the image, relying on the fact that artificial blurring can be used to generate out-of-focus effects. The use of tiled focus stack 304 can thereby further reduce storage and/or bandwidth requirements.

Further details describing operation of tiled focus stack 304, along with an example, are provided herein.

Extended Depth-of-Field Image 305

Extended depth-of-field (EDOF) image 305 is another type of asset 150 that can be included. In an EDOF image 305, substantially all portions of the image are in focus. EDOF image 305 can be generated using any known technique, including pre-combining multiple images taken at different focus depths. The use of an EDOF image 305 can further reduce storage and/or bandwidth requirements, since multiple images with different focus depths need not be stored. If desired, refocusing can be simulated by selectively blurring portions of the EDOF image 305.

Sub-Aperture Images 306

In at least one embodiment, a set of sub-aperture image(s) (SAIs) 306 is included. The use of sub-aperture images is described in Ng et al., “Light Field Photography with a Hand-Held Plenoptic Camera”, Technical Report CSTR 2005-02, Stanford Computer Science, and in related U.S. Utility Application Serial No. 13/027,946 for “3D Light Field Cameras, Images and Files, and Methods of Using, Operating, Processing and Viewing Same” (Atty. Docket No. LYT3006), filed on Feb. 15, 2011, the disclosure of which is incorporated herein by reference. In at least one embodiment, representative rays are culled, such that only rays that pass through a contiguous sub-region of the main-lens aperture are projected to the 2-D image. The contiguous sub-region of the main-lens aperture is referred to herein as a sub-aperture, and the resulting image is referred to as a sub-aperture image. The center of perspective of a sub-aperture image may be approximated as the center of the sub-aperture. Such a determination is approximate because the meaning of “center” is precise only if the sub-aperture is rotationally symmetric. The center of an asymmetric sub-aperture may be computed just as the center of gravity of an asymmetric object would be. Typically the aperture of the main lens is rotationally symmetric, so the center of perspective of a 2-D image that is projected with all of the representative rays (i.e., the sub-aperture is equal to the aperture) is the center of the main-lens aperture, as would be expected.

Thus, each SAI is a relatively low-resolution view of the scene taken from a slightly different vantage point. Any number of SAIs can be included. By selecting from a number of available SAIs, a parallax shift can be simulated. Interpolation can be used to smooth the transition from one SAI to another, thus reinforcing the illusion of side to side movement. Low-resolution SAIs are suitable for use with relatively small screens. In such an environment, SAIs can provide 3D parallax capability without consuming large amounts of storage space or bandwidth.

Extended Depth of Field Images from Different Perspectives

As with sub-aperture images, EDOF images may also be computed from different vantage points to match the perspective views of corresponding sub-aperture images. Unlike such sub-aperture images, however, EDOF images computed for different vantage points retain the full resolution and quality of EDOF images in general. Such a set of EDOF images may be used to effect a parallax shift or animation similarly as for sub-aperture images. If desired, refocusing may be implemented by using a “shift-and-add”technique as described for sub-aperture images in Ng et al., “Light Field Photography with a Hand-Held Plenoptic Camera”, Technical Report CSTR 2005-02, Stanford Computer Science.

Depth Map 307

Depth map 307 is another type of asset 150 that can be included. In at least one embodiment, depth map 307 specifies a focus depth value (indicating focus depth) for each pixel (or for some subset of pixels) in an image. Depth map 307 can be provided at full resolution equaling the resolution of the image itself, or it can be provided at a lower resolution. Depth map 307 can be used in connection with any of the other assets 150 in generating final image 107. More particularly, for example, depth map 307 can indicate which parts of an image are associated with different depths, so that appropriate parts of the image can be retrieved and used depending on the desired focus depth for final image 107. One skilled in the art will recognize that depth map 307 can be used in other ways as well, either on its own or in combination with other assets 150.

Acceleration Structure 308

In at least one embodiment, acceleration structure 308 defines one or more combination(s) of assets 150, and specifies when each particular asset 150 should or should not be included within LFP file 203. Assets 150 can be combined in different ways to provide different features based on device attributes and/or other factors. For example, if the processing capability of device 105 is insufficient to render light field image data 301, such data can be omitted from LFP file 203 provided to such device 105; rather, a focus stack 303 may be provided, to allow device 105 to offer refocusing capability without having to render light field images. Alternatively, if no refocusing capability is needed or desired, focus stack 303 can be omitted, and a suitable asset 150 such as a flat image can be provided instead.

The following are examples of the use of acceleration structure 308 to define combinations of assets 150 to be used to enable different types of features and attributes.

Refocusing

Refocusing capability can be enabled by combining SAIs 306 to obtain refocusable images. In at least one embodiment, SAIs 306 are shifted and summed, according to techniques that are well known in the art and described, for example, in Ng et al. This technique is referred to as “shift-and-add”.

Alternatively, refocusing can be accomplished by using an EDOF image 305, and selectively blurring portions of the image based on information from depth map 307.

Alternatively, refocusing can be accomplished by generating a focus stack 303 containing a number of 2D images, so that an appropriate image can be selected from focus stack 303 based on the desired focus depth. Interpolation and smoothing can be used to generate images at intermediate focus depths.

In at least one embodiment, the determination of which method to use in order to enable refocusing capability can be made based on processing power of device 105, quality/resolution needed or desired, download size desired (based, for example, on bandwidth constraints), and/or other factors. In many cases, the different refocus methods represent different trade-offs among these factors and limitations. Accordingly, in at least one embodiment, acceleration structure 308 defines a combination of assets 150 and a methodology for implementing refocusing capability, based on device 105 limitations and other factors.

3D Stereo Capability. 3D stereo capability can be implemented by providing two versions of all relevant assets 150; for example, two focus stacks 303 or EDOF images 305: one for each eye (i.e., one for each of two stereo viewpoints). Alternatively, a single focus stack 303 or EDOF image 305 can be provided, which contains all the information needed for 3D stereo viewing; for example, it can contain pre-combined red/cyan images overlaid on one another to permit stereo viewing by extraction of the red and cyan images (3D glasses can be used for such extraction). Alternatively, 3D parallax assets can be used to generate 3D stereo images on-the-fly at device 105.

Again, in at least one embodiment, the determination of which method to use in order to enable 3D stereo capability can be made based on processing power of device 105, quality/resolution needed or desired, download size desired (based, for example, on bandwidth constraints), and/or other factors. Accordingly, in at least one embodiment, acceleration structure 308 defines a combination of assets 150 and a methodology for implementing 3D stereo capability, based on device 105 limitations and other factors.

3D Parallax Capability

3D parallax capability can be implemented by providing multiple SAIs 306; since each contains a view of the scene from a different viewpoint, parallax shifts can be simulated by selection of individual SAIs. Such an approach generally offers low resolution results, and may therefore be suitable for devices 105 having smaller screens. Interpolation can be performed to smooth the transition from one viewpoint to another, and/or to implement intermediate viewpoints.

Alternatively, 3D parallax capability can be implemented using EDOF image 305 together with depth map 307. A 3D mesh can be generated from depth map 307, specifying spatial locations for items within EDOF image 305. A virtual camera can navigate the 3D environment defined by the mesh; based on the movement of this camera, projections can be generated. Items in the EDOF image 305 can be synthetically warped to generate the 3D parallax images.

In some cases, items may be occluded in the EDOF image 305 so that they are not available for display in the 3D environment. If those items need to be displayed, lower resolution versions available from SAIs 306 can be used to fill in the gaps. SAIs 306 can also be used to fill in any areas where insufficient image data is available from the EDOF image 305.

In this manner, an alternative approach to 3D parallax capability is enabled, which may provide improved performance in environments where generation of a 3D mesh and navigation with a 3D environment are feasible, for example if a graphics processing unit is available at device 150.

Alternative Mechanism for Refocusing, 3D Stereo, and Parallax Capability

In at least one embodiment, refocusing, 3D stereo, and parallax capability can be enabled using a set of high-quality, high-resolution EDOF images 305, each taken from a different viewpoint. A depth map 307 may or may not be included. In this embodiment, instead of warping a single EDOF image 305 to effect viewpoint changes, the system selects and uses one of the EDOF images 305 that has a viewpoint approximating the desired viewpoint. These EDOF images 305 are used as high-quality SAIs, and can be used to drive animations, as follows:
Viewpoint can be changed by selecting a suitable EDOF image 305 from the set;
3D stereo can be implemented by providing two (or more) EDOF images 305, one for each eye;
Refocusing can be implemented using the shift-and-add technique described above in connection with SAIs 306.

Any or all of the above capabilities can be implemented using various combinations of assets 150. In addition, any of these capabilities can be further enhanced by providing animations that depict smooth transitions from one view to another. For example, refocusing can be enhanced by providing transitions from one focus depth to another; smooth transitions can be performed by selectively displaying images from a focus stack or tiled focus stack, and/or by interpolating between available images, combining available images, and/or any other suitable technique.

### Focus Stack

One example of an asset 150 is a focus stack. A focus stack is a set of refocused images and/or 2D images, possibly of the same or similar scene at different focus depths. A focus stack can be generated from a light field image by projecting the light field image data at different focus depths and capturing the resulting 2D images in a known 2D image format. Such an operation can be performed in advance of a request for image data, or on-the-fly when such a request is received. Once generated, the focus stack can be stored in data storage 104. The focus stack can be made available as an asset 150 in response to requests for refocusable image data. For example, if the particular attributes of device 105 dictate that the image can be refocused based on user 110 input, a focus stack can be provided to device 105 to enable such refocusing. In particular, the focus stack can be provided in situations where it is not feasible for the entirety of the light field data to be transmitted to device 105 (for example, if device 105 does not have the capability or the processing power to render light field data in a satisfactory manner). Device 105 can thus render refocusing effects by selecting one of the images in the focus stack to be shown on output device 106, without any requirement to render projections of light field data. In at least one embodiment, device 105 can use multiple images from the focus stack; for example, such images can be blended with one another, and/or interpolation can be used, to generate smooth depth transition animations and/or to display images at intermediate focus depths.

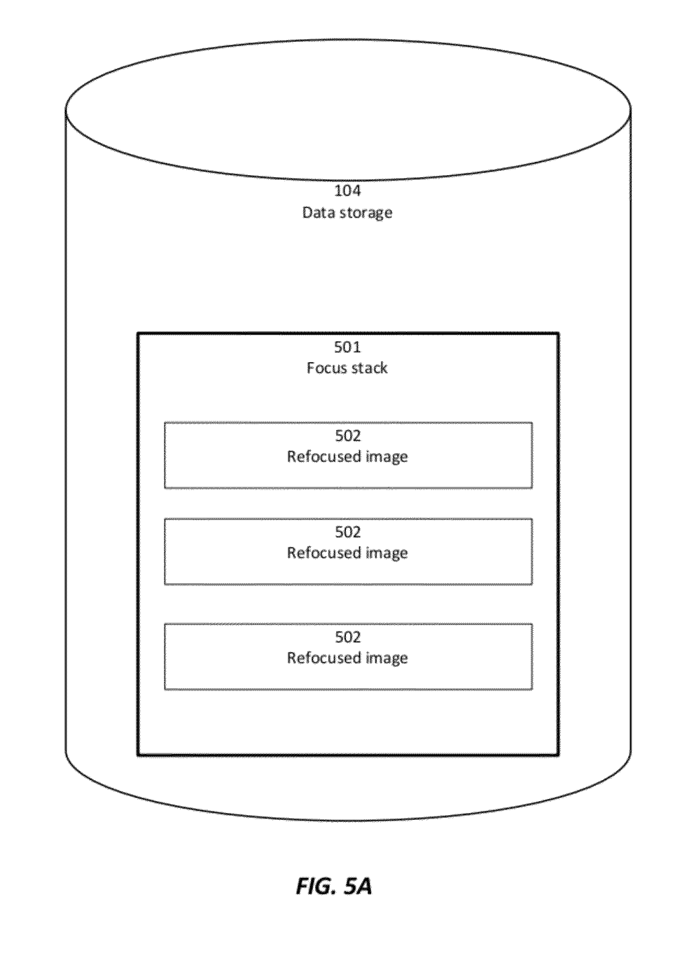

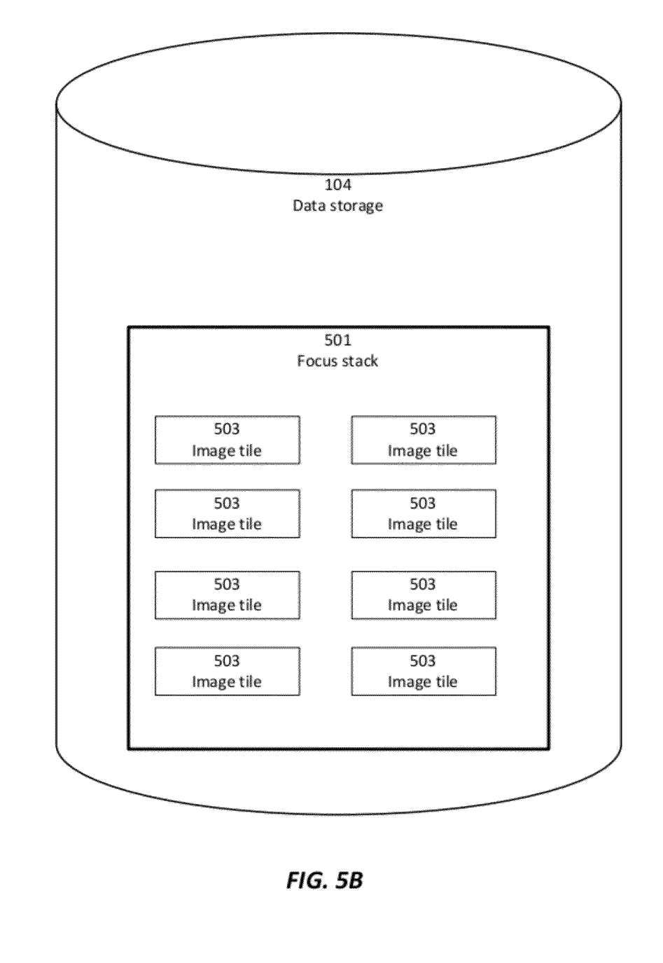

Referring now to FIG. 5A, there is shown an example of a conceptual architecture for a focus stack 501 containing multiple images 502 and stored in a data storage device 104, according to one embodiment. One skilled in the art will recognize that any number of images 502 can be included in focus stack 501. In at least one embodiment, each image 502 is a refocused image that is generated from light field data by projecting the light field image data at different focus depths and capturing the resulting 2D images in a known 2D image format. Each image 502 can be stored using any suitable image storage format, including digital formats such as JPEG, GIF, PNG, and the like. Any suitable data format can be used for organizing the storage of focus stack 501, for relating images 502 to one another, and/or to indicate a focus depth for each image 502. For example, in at least one embodiment, focus stack 501 can be implemented as a data format including a header indicating focus depths for each of a number of images 502, and pointers to storage locations for images 502.

### Tiled Focus Stack

In at least one embodiment, as described above, each image 502 in focus stack 501 represents a complete scene. Thus, in depicting the scene at output device 106 of device 105, a single image 502 is used, or a set of two or more images 502 are blended together in their entirety.

Alternatively, in at least one embodiment, assets 150 can include image tiles, each of which represent a portion of the scene to be depicted. Multiple image tiles can be combined with one another to render the scene, with different image tiles being used for different portions of the scene. For example, different image tiles associated with different focus depths can be used, so as to generate an image wherein one portion of the image is at a first focus depth and another portion of the image is at a different focus depth. Such an approach can be useful, for example, for images that include elements having significant foreground and background elements that are widely spaced in the depth field. If desired, only a portion of the image can be stored at each focus depth, so as to conserve storage space and bandwidth.

Referring now to FIG. 5B, there is shown an example of a conceptual architecture for a tiled focus stack 501 containing multiple image tiles 503 and stored in a data storage device 104, according to one embodiment. One skilled in the art will recognize that any number of image tiles 503 can be included in focus stack 501; image tiles 503 can be provided in addition to or instead of complete images 502. In at least one embodiment, each image tile 503 is a portion of a refocused image that is generated from light field data by projecting the light field image data at different focus depths and capturing the desired portions of the resulting 2D images in a 2D image format. Each image tile 503 can be stored using any suitable image storage format, including digital formats such as JPEG, GIF, PNG, and the like. Any suitable data format can be used for organizing the storage of focus stack 501, for relating image tiles 503 to one another, and/or to indicate a focus depth for each image tile 503. For example, in at least one embodiment, focus stack 501 can be implemented as a data format including a header indicating focus depths for each of a number of image tiles 503 and further indicating which portion of the overall scene that image tile 503 represents; the data format can also include pointers to storage locations for image tiles 503.

Tiling can be performed in any of a number of different ways. In at least one embodiment, the image can simply be divided into some number of tiles without reference to the content of the image; for example, the image can be divided into four equal tiles. In at least one other embodiment, the content of the image may be taken into account; for example, an analysis can be performed so that the division into tiles can be made intelligently. Tiling can thus take into account positions and/or relative distances of objects in the scene; for example, tiles can be defined so that closer objects are in one tile and farther objects are in another tile.

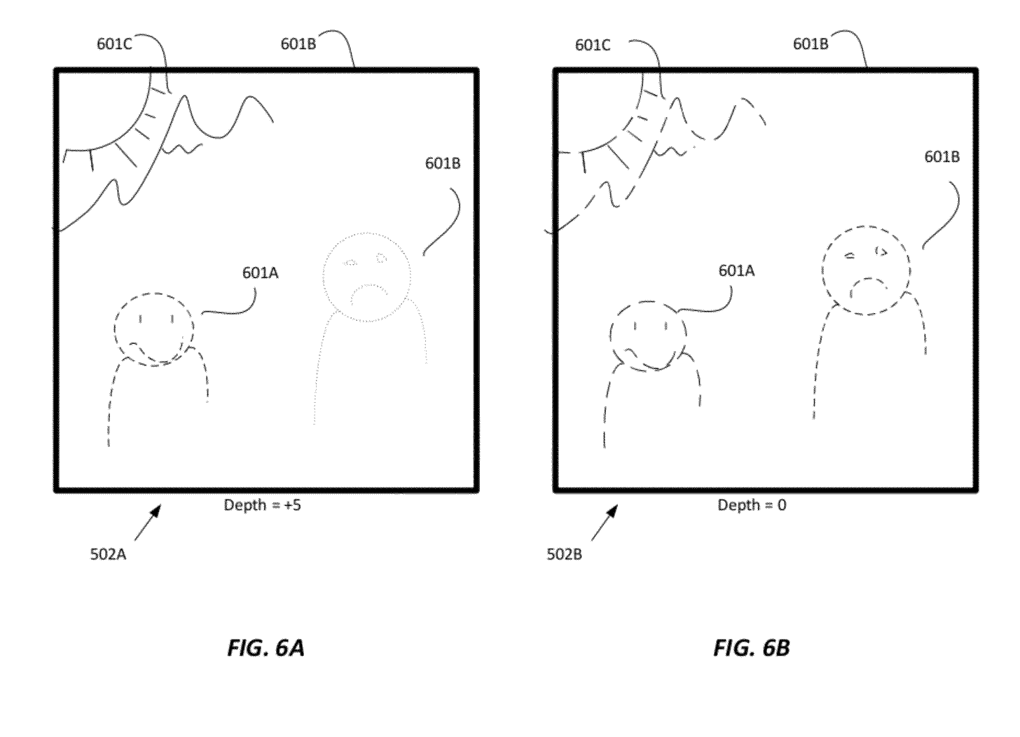

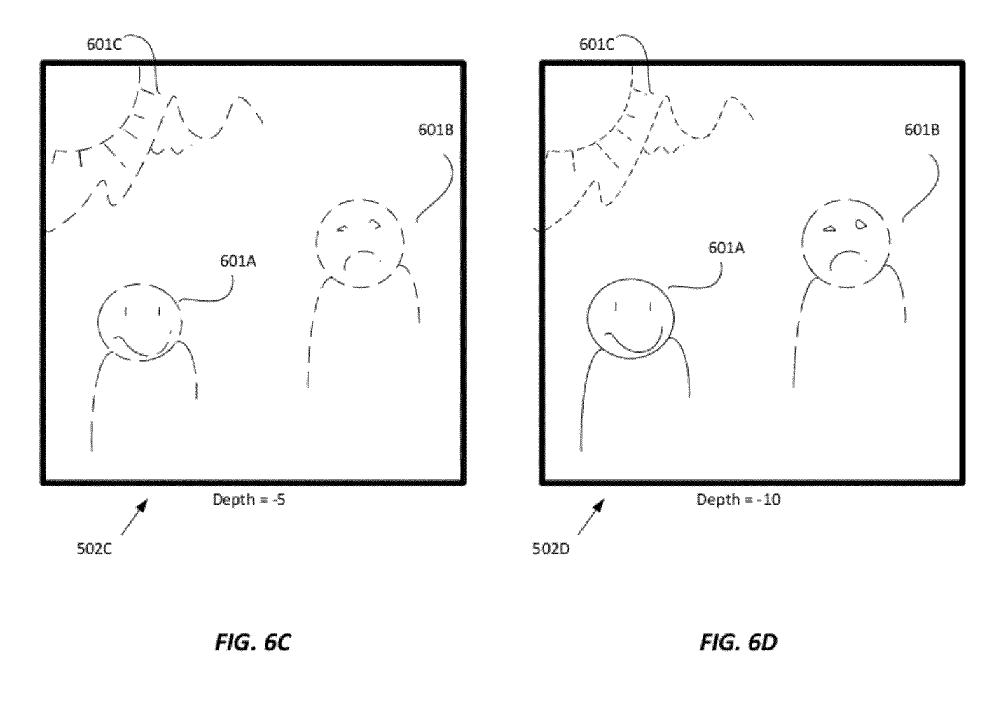

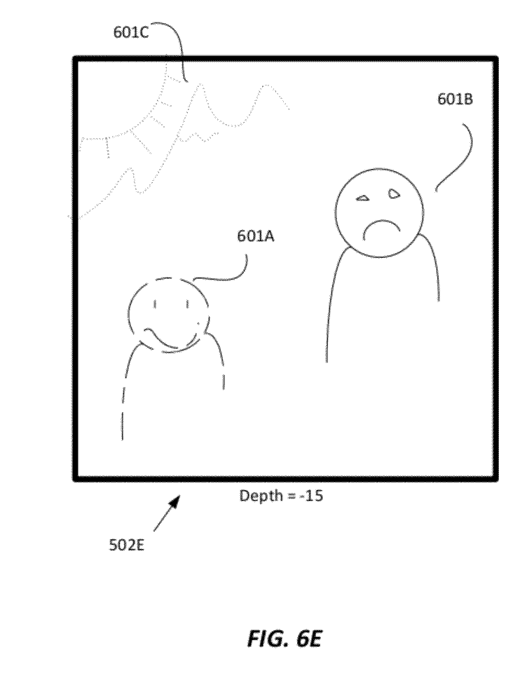

Referring now to FIGS. 6A through 6E, there is shown a series of examples of images 502 associated with different focal lengths and stored in a focus stack 501, according to one embodiment. For each such image 502, a depth value is shown, representative of a focus depth.

In FIG. 6A, image 502A is depicted, representing the image when it has been refocused with depth value of +5. Object 601C, which is farther away from the camera, is in focus; object 601A, which is closer to the camera, is out of focus; object 601B, which is even closer to the camera than object 601A, is even more out of focus. FIGS. 6B through 6E depict images 502B through 502E, respectively, each of which is refocused with successively lower depth values indicating focus depths that are closer to the camera. Accordingly, in each image 502B through 502E, object 601C appears more and more out of focus, and object 601B appears more and more in focus. Object 601A, having a moderate distance from the camera, appears in focus in image 502D.

As described above, in at least one embodiment, images can be divided into tiles 503, thus facilitating assembly of a final images 107 from multiple portions depicting different regions of a scene. Such a technique allows different portions of an image to be presented in focus, even if the portions represent parts of the scene that were situated at drastically different distances from the camera.

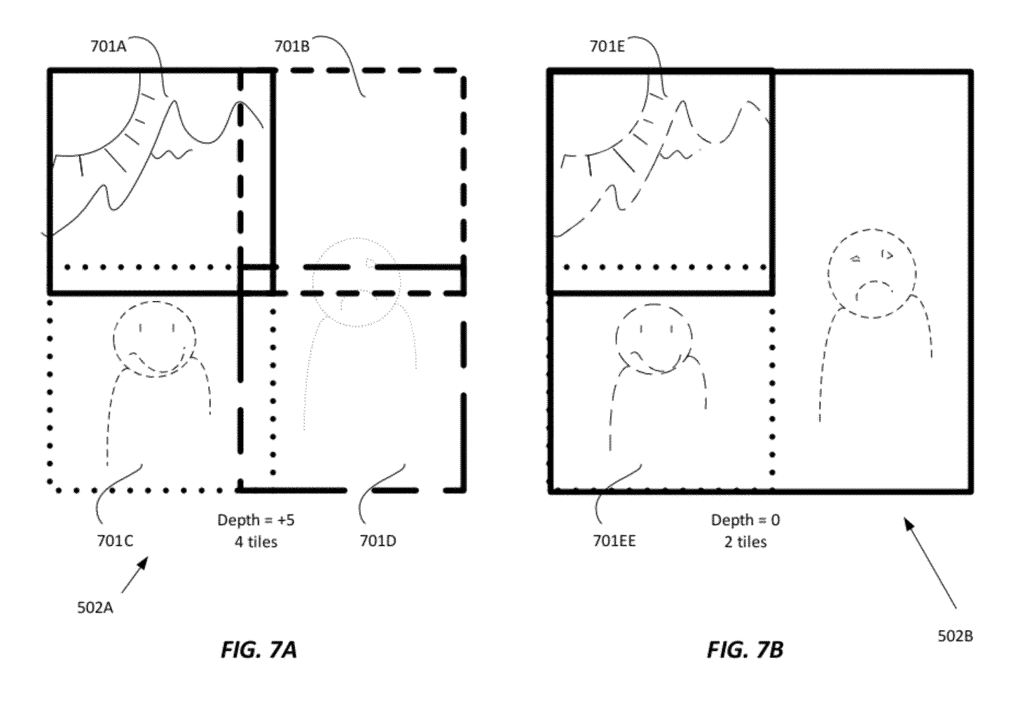

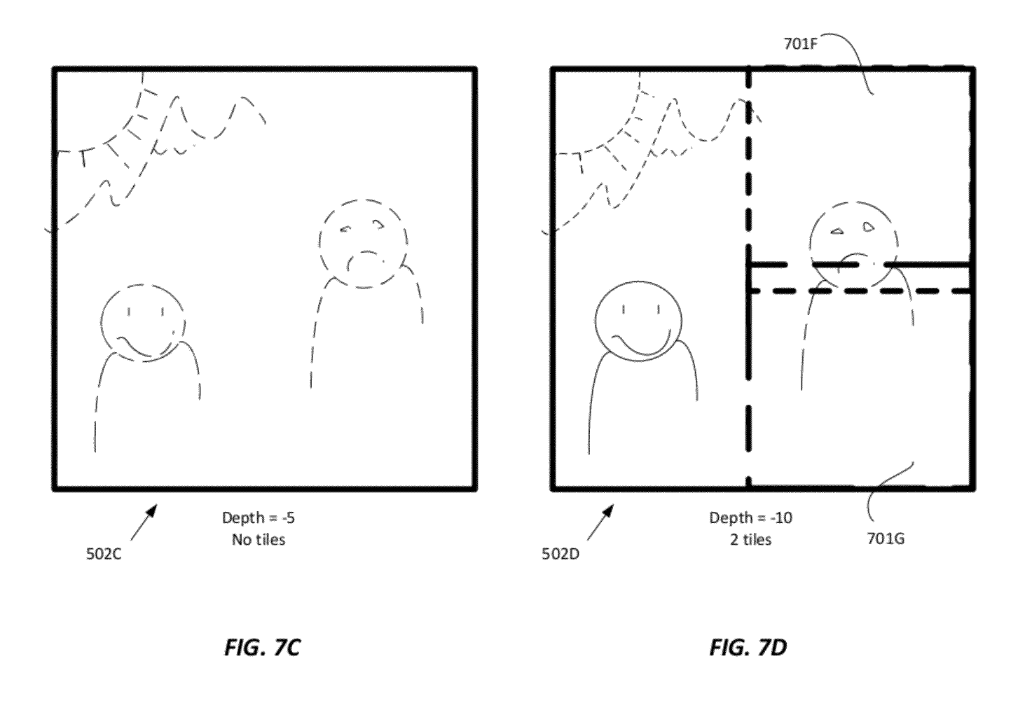

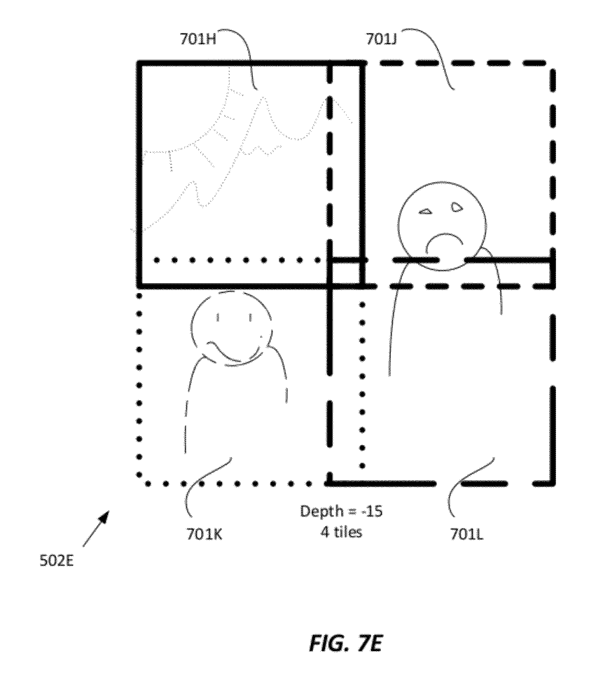

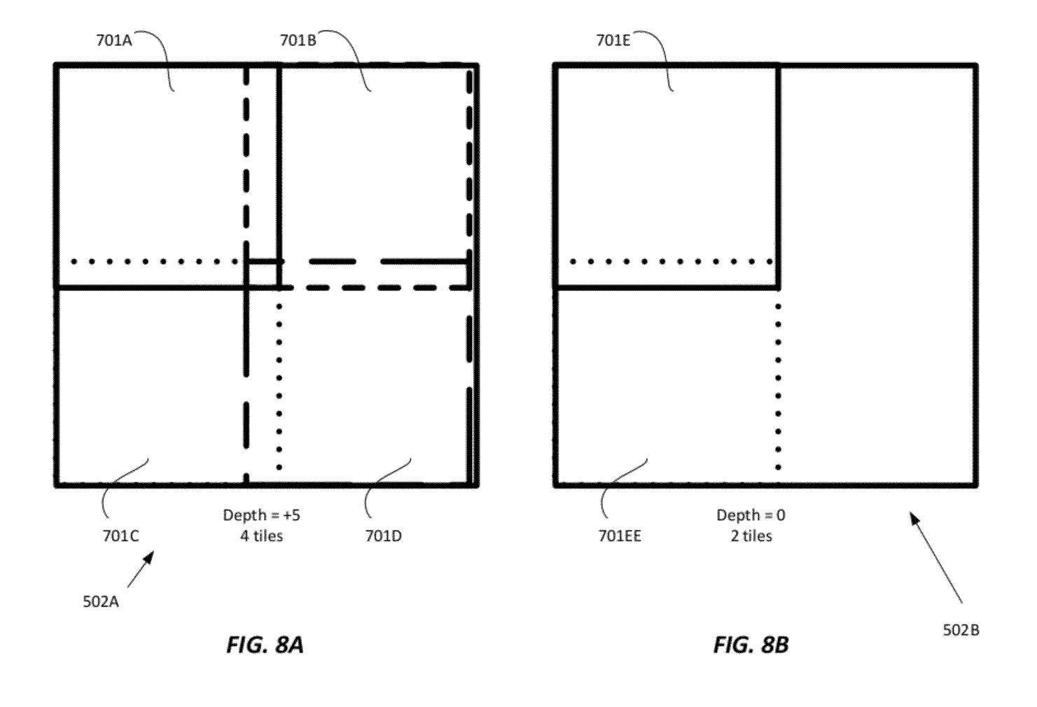

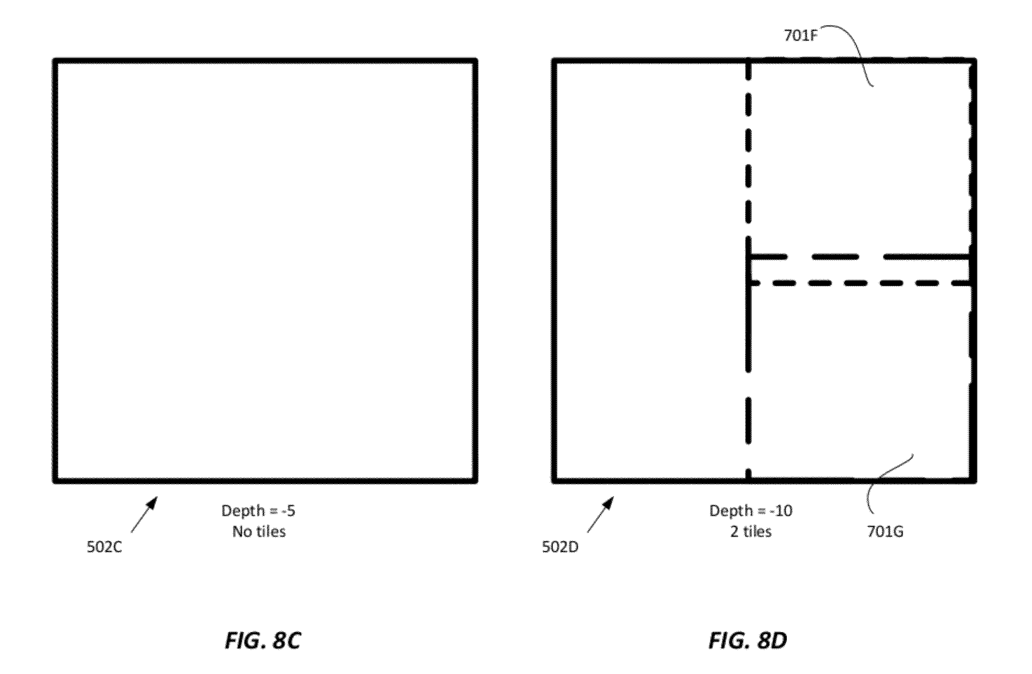

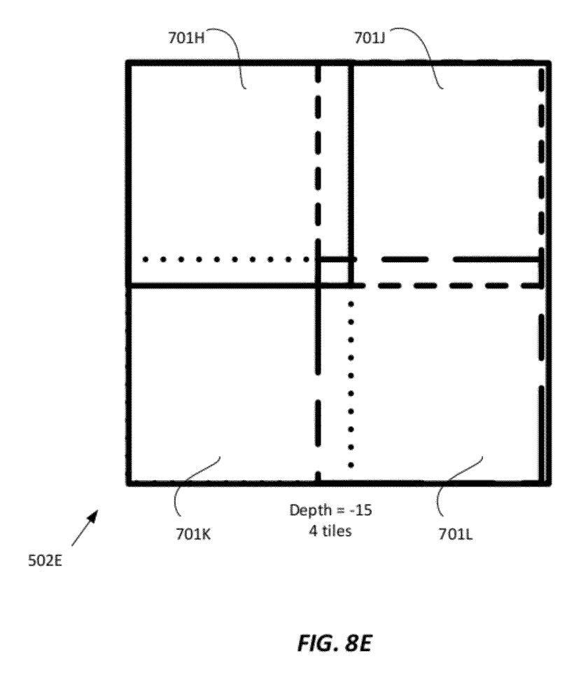

Referring now to FIGS. 7A through 7E, there is shown a series of examples of possible tilings of the images depicted in FIGS. 6A through 6E, according to one embodiment. Referring now also to FIGS. 8A through 8E, there are shown the tilings of FIGS. 7A through 7E, with the images removed for clarity. For illustrative purposes, out-of-focus elements are shown using dotted or dashed lines, with the lengths of the dashes indicating a relative degree to which the element is out of focus.

In FIGS. 7A and 8A, image 502A having a depth value of +5 has been divided into four tiles 701A through 701D, each representing different portions of the scene having different distances from the camera. As shown in the examples of FIGS. 7A and 8A, tiles 701 can (but need not) overlap one another. Where overlapping tiles 701 are available, the overlapping portions of two or more tiles 701 can be blended with one another to improve the smoothness of the transition from one area of final image 107 to another.

In FIGS. 7B and 8B, image 502B having a depth value of 0 has been divided into two tiles 701E and 701EE, each representing different portions of the scene having different distances from the camera. In this example, the portion of image 502B that lies outside tiles 701E and 701EE is not stored or used.

In FIGS. 7C and 8C, it is determined that no portion of image 502C is used; thus no tiles are made available.

In FIGS. 7D and 8D, image 502D having a depth value of −10 has been divided into two tiles 701F and 701G, each representing different portions of the scene having different distances from the camera. In this example, the portion of image 502D that lies outside tiles 701F and 701G is not stored or used.

In FIGS. 7E and 8E, image 502E having a depth value of −15 has been divided into four tiles 701H through 701L, each representing different portions of the scene having different distances from the camera.

In at least one embodiment, an automated analysis is performed to determine which tiles 701, if any, should be extracted and stored for each refocused image 502. For example, in the above-described example, it is automatically determined that no tiles from image 502C are needed, because no area of the image 502C is sufficiently in focus to be of use. This automated determination can take into account any suitable factors, including for example, characteristics of the image 502 itself, available bandwidth and/or storage space, available processing power, desired level of interactivity and number of focus levels, and/or the like.

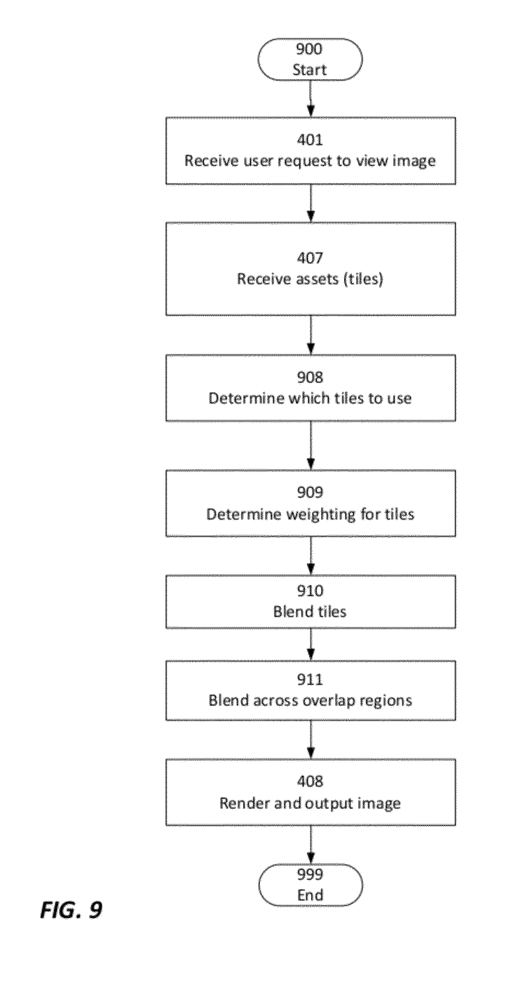

Referring now to FIG. 9, there is shown a flow diagram depicting a method of generating an image 107 from tiles 503 of a focus stack 501, according to one embodiment. Device 105 receives 401 a request from user 110 to view an image. Such request can be provided, for example, via input provided at input device 108. For example, user 110 may navigate to an image within an album, or may retrieve an image from a website, or the like. In at least one embodiment, the techniques of the present invention can be applied to images that are presented automatically and without an explicit user request; for example, in response to an incoming phone call wherein it may be desired to show a picture of the caller, or in response to automatic activation of a screen saver for depicting images.

Device 105 receives 407 assets 150 for depicting the images. Steps 402 to 406, described above in connection with FIG. 4, may be performed prior to step 407, but are omitted in FIG. 9 for clarity. By performing steps 402 to 406, device 105 can request and receive assets 150 that are suited to the particular attributes of device 105, software 151 running on device 105, context of the image display request, and/or any other factors. In the example of FIG. 9, such assets 150 include image tiles 701.

Based on the user request received in step 401, device 105 determines 908 which tiles 701 should be used in generating final image 107. Such determination 908 can be made, for example, based on a desired focus depth for final image 107. For example, user 110 can interact with a user interface element to specify that a particular portion of the image is to be in focus (and/or to specify other characteristics of the desired output image); based on such input, appropriate tiles 701 are selected to be used in generating final image 107.

In at least one embodiment, multiple tiles 701 representing different portions of the image are stitched together to generate final image 107. In at least one embodiment, multiple tiles 701 representing the same portion of the image are used, for example by interpolating a focus depth between two available tiles 701 for the same portion of the image. In at least one embodiment, these two blending techniques are both used.

FIG. 9 depicts examples of steps for performing such operations. In at least one embodiment, prior to blending 910 tiles 701 representing the same portion of the image, device 105 determines 909 weighting for tiles 701, for example to interpolate a focal distance between the focal distance of the individual tiles. For example, if the desired focal distance is closer to that of one tile than that of another tile, the weighting can reflect this, so that the first tile is given greater weight in the blending operation than the second tile.

As mentioned above, in at least one embodiment, device 105 blends 911 together, or stitches, tiles 701 representing different portions of the image. Such blending 911 can take advantage those regions where tiles 701 overlap one another, if available. In embodiments where no overlap is available, blending 911 can be performed at the border between tiles 701.

Once steps 910 and 911 are complete, final image 107 is rendered and output 408.

In at least one embodiment, device 105 stores and/or receives only those tiles 701 that are needed to enable the particular features desired for a particular image display operation, given the attributes of device 105.

The following is an example of the application of the method of FIG. 9 to the examples depicted in FIGS. 7A through 7E, in order to generate a final image 107 having depth value of −5:
Blend tiles 701E and 701EE from image 502B (having depth value=0) with respective tiles 701H and 701K from image 502E (having depth value=−15). Tiles 701E and 701EE from image 502B are given a blending weight (i.e. alpha) of 10/15=0.67, and tiles 701H and 701K from image 502E are given a blending weight of 5/15=0.33. This reflects the fact that the desired depth value is closer to the depth value of tiles 701E and 701EE.
Blend tiles 701B and 701D from image 502A (having depth value=+5) with respective tiles 701F and 701G from image 502D (having depth value=−10). Tiles 701B and 701D from image 502A are given a blending weight of 5/15=0.33, and tiles 701F and 701G from image 502D are given a blending weight of 10/15=0.67. This reflects the fact that the desired depth value is closer to the depth value of tiles 701F and 701G.
The result of these two steps is a set of two images, each of which spans half the scene. These two images are then blended, or stitched, together, spatially blending across the overlap region to make the seam invisible. The final image 107 is then output.

### Data Format

Any suitable data format can be used for storing data in LFP file 203. In at least one embodiment, the data format is configured so that device 105 is able to query LFP file 203 to determine what assets 150 are present, what features and capabilities are available based on those assets 150, and what is best the match between such features/capabilities and available assets 150. In this manner, the data format allows device 105 to determine the best combination of assets 150 to retrieve in order to achieve the desired results.

In at least one embodiment, metadata 302 and/or other data in LFP files 203 are stored in JavaScript Object Notation (JSON), which provides a standardized text notation for objects. JSON is sufficiently robust to provide representations according to the techniques described herein, including objects, arrays, and hierarchies. JSON further provides a mechanism which is easy for humans to read, write, and understand.

One example of a generalized format for a JSON representation of an object is as follows:

| | |
|---|---|
| object | ::= { } \| { members } |
| members | ::= pair \| pair , members |
| pair | ::= string : value |
| array | ::= [ ] \| [ elements ] |
| elements | ::= value \| value , elements |
| value | ::= string \| number \| object \| array |

true | false | null

| | |
|---|---|
| string | ::= ”” \| ”chars” |
| number | ::= int \| intFrac \| intExp \| intFracExp |

Thus, the JSON representation can be used to store frame metadata in a key-value pair structure.

As described above, frame metadata may contain information describing the camera that captured an image. An example of a portion of such a representation in JSON is as follows:

”camera” :
{

”make” : ”any_make”,
”model” : ”any_model”
”firmware” : ”3.1.41 beta”

}

Data stored in the JSON representation may include integers, floating point values, strings, Boolean values, and any other suitable forms of data, and/or any combination thereof.

Given such a structure, device 105 can access data in an LFP file 203 by performing a key lookup, and/or by traversing or iterating over the data structure, using known techniques. In this manner, device 105 can use any suitable assets 150 found within LFP file 203 or elsewhere when generating final image(s) 107.

The JSON representation may also include structures; for example a value may itself contain a list of values, forming a hierarchy of nested key-value pair mappings. For example:

”key1” :
{

”key2” : {

”key3”:[2.12891, 1.0, 1.29492]

}

}

In at least one embodiment, binary data is stored in the JSON structure via a base64-encoding scheme.

Privacy concerns are addressed as described above. Identifying data, as well as any other data that is not critical to the interpretation of image data, may be provided in a removable section of metadata, for example in a separate section of the JSON representation. This section can be deleted without affecting image rendering operations, since the data contained therein is not used for such operations. An example of such a section is as follows:

```
“removable” : {
    “serial” : “520323552”,
    “gps” : { ... },
    ...
}
```

Data to be used in rendering images may be included in any number of separate sections. These may include any or all of the following:
a description section, providing a general description of the equipment used (without specific identifying information)
an image section, containing image data;
a devices section, specifying settings and parameters for the equipment used;
a light field section, containing light field data (if the frame contains a light field image);

One skilled in the art will recognize that these are merely exemplary, and that any number of such sections can be provided.

Description section can contain any information generally describing the equipment used to capture the image. An example of a description section is as follows:

```
”camera” :
{
  ”make” : ”any_make”,
  ”model” : ”any_model”
  ”firmware” : ”3.1.41 beta”
}
```

Image section contains image data. Image section can contain color-related fields for converting raw images to RGB format. Image section can contain a “format” value indicating whether the format of the image is “raw” or “rgb”. In addition, various other fields can be provided to indicate what corrections and/or other operations were performed on the captured image.

An example of an image section is as follows:

```
“image” : {
    “timeStamp” : “2009:07:04 03:00:46 GMT”,
    “orientation” : 1,
    “width” : 4752,
    “height” : 3168,
    “format” : “raw”,
    “raw” : {
        “mosaic” : {
            “type” : “r,g;g,b”,
            “firstPixelMosaicIndex” : { “x” : 0, “y” : 1 } },
        “pixelRange” : { “black” : 1024, “white” : 15763 },
        “pixelFormat” :
            { “bpp” : 16, “endian” : “little”, “shift” : 4 } },
    “whiteBalanceMultipliers” : [2.12891, 1, 1.29492],
    “ccmRgbToSrgb” :
        [ 2.26064,  −1.48416,  0.223518,
        −0.100973,  1.59904, −0.498071,
          0.0106269,  −0.58439,  1.57376] },
    “gamma” : [0, 1, 2, 4, 6, 9, ..., 4050, 4070, 4092]
}
```

Devices section specifies camera hardware and/or settings; for example, lens manufacturer and model, exposure settings, and the like. In at least one embodiment, this section is used to break out information for component parts of the camera that may be considered to be individual devices. An example is as follows:

```
“devices” : {
    “lens” : {
        “make” : “any_make1”,
        “model” : “any_model2”,
        “macro” : true,
        “focalLength” : 50,
        “fNumber” : 4,
        “motorPosition” : { “zoom” :  200, “focus” : 120 } },
    “flash” : {
        “make” : “any_make2”,
        “model” : ”any_model2”,
        “firmware” : “beta”,
        “brightness” : 2.3,
        “duration” : 0.1 },
    “ndfilter” : { “stops” : 3.0 },
    “sensor” : {
        “exposureDuration” : 0.1,
        “iso” : 400,
        “analogGain” : 34.0,
        “digitalGain” : 1.0 }
    “accelerometer” : { “samples” : [ ... ] }
}
```

Light field section provides data relating to light fields, image refocusing, and the like. Such data is relevant if the image is a light field image. An example is as follows:

```
“lightfield” : {
    “index” : 1,
    “mla” : {
        “type” : “hexRowMajor”,
        “pitch” : 51.12,
        “scale” : { “x” : 1, “y” : 1 },
        “rotation” : 0.002319,
        “sensorOffset” : { “x” : −15.275, “y” : −44.65, “z” : 200 },
        “defects” : [ { “x” : 1, “y” : 3}, { “x” : 28, “y” : 35} ]
    },
    “sensor” : { “pixelPitch” : 4.7 },
    “lens” : {
        “exitPupilOffset” : { “x” : 0.0, “y” : 0.0, “z” : 57.5 }
    },
}
```

In at least one embodiment, the “defects” key refers to a set of (x,y) tuples indicating defective microlenses in the microlens array. Such information can be useful in generating images, as pixels beneath defective microlenses can be ignored, recomputed from adjacent pixels, down-weighted, or otherwise processed. One skilled in the art will recognize that various techniques for dealing with such defects can be used. If a concern exists that the specific locations of defects can uniquely identify a camera, raising privacy issues, the “defects” values can be omitted or can be kept hidden so that they are not exposed to unauthorized users.

Frame digests are supported by the JSON data structure. As described above, a digest can be stored as both a hash type and hash data. The following is an example of a digest within the removable section of a JSON data structure:

```
“removable” : {
    “serial” : “520323552”,
    “gps” : { ... },
    “digest” : {
        “type” : “shal”,
        “hash” : “ 2fd4e1c67a2d28fced849ee1bb76e7391b93eb12” }
}
```

In various embodiments, metadata (such as JSON data structures) can be included in a file separate from the image itself. Thus, one file contains the image data (for example, img_{—}0021.jpg, img_{—}0021.dng, img_{—}0021.raw, or the like), and another file in the same directory contains the JSON metadata (for example, img_{—}0021.txt). In at least one embodiment, the files can be related to one another by a common filename (other than the extension) and/or by being located in the same directory.

Alternatively, the image data and the metadata can be stored in a single file. For example, the JSON data structure can be included in an ancillary tag according to the exchangeable image file format (EXIF), or it can be appended to the end of the image file. Alternatively, a file format can be defined to include both image data and metadata.

### Example

The following is an example of the operation of the invention according to one embodiment. One skilled in the art will recognize that this example is intended to be illustrative only, and that many other modes of operation can be used without departing from the essential characteristics of the present invention, as defined in the claims.

Suppose device 105 is a mobile device (such as an iPhone) having the following characteristics:
Small screen, with resolution of 960×480 pixels
Connection to low-bandwidth network (such as 3G wireless)
Graphics processing unit (GPU)
Accelerometer

Suppose the desired feature is to deliver real-time parallax shifting as accelerometer is tilted.

Device 105 queries server 109 via the Internet, using a handshaking mechanism. The query specifies the characteristics of device 105 and the desired feature. Server 109 responds with links to assets 150 needed to enable the desired feature, given the specified characteristics. Alternatively, device 105 can determine what assets 150 are needed and request them.

Device 105 submits 406 the request for the specified assets 150 using the provided links. For this example, such assets 150 might include:
EDOF image at screen resolution of 960×480 pixels
Depth map at lower resolution such as 320×320
Ten SAIs at lower resolution such as 320×320

Specific sizes for these assets 150 can be selected based, for example, on a menu of available sizes. For example, sizes can be made available for a number of commonly used devices, such as for example an iPhone.

Upon receiving these assets 150, device 105 uses its GPU to perform warping on items in the EDOF image, based on the depth map, so as to generate the parallax effect. In this manner, the device 105 has been provided with those assets 150 that are best suited to this approach for enabling the desired feature, while minimizing waste of resources.

The above example is merely exemplary. Different devices, different software, and/or players on different devices, might have different characteristics and features.

### Example of JSON Specification

The following is an example of a JSON specification for LFP files 203 according to one embodiment. One skilled in the art will recognize that this example is intended to be illustrative only, and that many other variables, formats, arrangements, and syntaxes can be used without departing from the essential characteristics of the present invention, as defined in the claims.

In various embodiments, any number of extensions can be made to the JSON specification; these may be provided, for example, for certain types of equipment or vendors according to one embodiment.

The following is an example of such an extension:

```
VENDOR_FRAME_PARAMETER_OBJ ::=
  {
    “com.lytro.tags” :
    {
```

| | |
|---|---|
| “darkFrame” : BOOLEAN, | // optional. |

(false) shutter may or may not have opened, but no light reached the
sensor.

| | |
|---|---|
| “modulationFrame” : BOOLEAN | // optional. |

(false) intended to serve as a modulation image (flat-field or dark
frame).

| | |
|---|---|
| // “eventArray” : [ FRAME_PARAMETER_EVENT_OBJ ] | // optional. Add |
| if/when variable frame parameters are required. | |
| } | |
| } | |
| VENDOR_VIEW_TYPE_ENUM ::= | |
| “com.lytro.stars” \| | |
| “com.lytro.parameters” | |
| VENDOR_VIEW_OBJ ::= | // view objects |
| are individually defined to match their types | |
| VIEW_STARS_OBJ \| | // corresponding |
| to vendor view type “com.lytro.stars” | |
| VIEW_OPERATORS_OBJ | // corresponding |
| to vendor view type “com.lytro.parameters” | |
| VIEW_STARS_OBJ ::= | |
| { | |
| “starred” : BOOLEAN | |
| } | |
| VIEW_OPERATORS_OBJ ::= | |
| { | |
| “eventArray” : [ VIEW_OPERATORS_EVENT_OBJ ] | // events are in |
| order. (This order trumps the time stamps in the individual events) | |
| } | |
| VIEW_OPERATORS_EVENT_OBJ ::= | |
| { | |
| “zuluTime” : STRING, | // ISO 8601, e.g., |

“2011-03-30T18:07:25.134Z”, fraction to millisecond, Zulu time (no local
offset)

| | |
|---|---|
| “viewTurns” : TURN, | // optional. (0) |
| // “viewTurnsArray” : [ TURN ], | // optional. (0) |
| Should not be present if “viewTurns” is present. Array length should | |
| match # of frames. | |
| “viewCrop” : VIEW_CROP_OBJ, | // optional. |
| // “viewCropArray” : [ VIEW_CROP_OBJ ], | // optional. |

Should not be present if “viewCrop” is present. Array length should match
# of frames.

| | |
|---|---|
| “viewBrightness” : NORMALIZED_VIEW_OPERATOR, | // optional. (0.5) |

// “viewBrightnessArray” : [ NORMALIZED_VIEW_OPERATOR ], // optional.
Should not be present if “viewBrightness” is present. Array length should
match # of frames.

| | |
|---|---|
| “viewContrast” : NORMALIZED_VIEW_OPERATOR, | // optional. (0.5) |
| // “viewContrastArray” : [ NORMALIZED_VIEW_OPERATOR ], | // optional. |

Should not be present if “viewContrast” is present. Array length should
match # of frames.

| | |
|---|---|
| “viewSaturation” : NORMALIZED_VIEW_OPERATOR, | // optional. (0.5) |

// “viewSaturationArray” : [ NORMALIZED_VIEW_OPERATOR ] // optional.
Should not be present if “viewBrightness” is present. Array length should
match # of frames.

| | |
|---|---|
| “viewSharpness” : NORMALIZED_VIEW_OPERATOR, | // optional. (0) |

// “viewSharpnessArray” : [ NORMALIZED_VIEW_OPERATOR ], // optional.
Should not be present if “viewSharpness” is present. Array length should
match # of frames.

| | |
|---|---|
| “viewDeNoise” : NORMALIZED_VIEW_OPERATOR, | // optional. (0) |
| // “viewDeNoiseArray” : [ NORMALIZED_VIEW_OPERATOR ], | // optional. |

Should not be present if “viewDeNoise” is present. Array length should
match # of frames.

| | |
|---|---|
| “viewColorTemperature” : NORMALIZED_VIEW_OPERATOR, | // optional. (0.5) |

// “viewColorTemperatureArray” : [ NORMALIZED_VIEW_OPERATOR ], //
optional.

| | |
|---|---|
| “viewTint” : NORMALIZED_VIEW_OPERATOR, | // optional. (0.5) |
| // “viewTintArray” : [ NORMALIZED_VIEW_OPERATOR ], | // optional. |

Should not be present if “viewTint” is present. Array length should match
# of frames.

| | |
|---|---|
| // “viewRefocusDof” : “normal” \| “extended” | // optional. |
| // “viewRefocusLambda” : LAMBDA | // optional. |
| // “viewRefocusLambdaSpec” : | // optional. |
| // { | |
| // “mode” : “coord” \| “lambda”, | |
| // “coord” : | |
| // { | |
| // “x” : PIXEL, | |
| // “y” : PIXEL | |
| // } | |
| // } | |
| } | |
| VIEW_CROP_OBJ ::= | |
| { | |
| “fromLeft” : PIXEL_COORD, | // (0) Pixels |
| removed from the left side of the image. | |
| “fromTop” : PIXEL_COORD, | // (0) Pixels |
| removed from the top of the image. | |
| “width” : PIXEL_COORD, | // (−1) Maximum |

width of the resulting image. (Excess removed from the right side.)

| | |
|---|---|
| “height” : PIXEL_COORD | // (−1) Maximum |

height of the resulting image. (Excess removed from the bottom.)

// For both

“width” and ‘height”, value −1 implies a size large enough to ensure that

// no cropping

happens on the right/bottom in that dimension.
}
VENDOR_ACCELERATION_TYPE_ENUM ::=

| | |
|---|---|
| “com.lytro.acceleration.refocusStack” \| | // |
| //“com.lytro.acceleration.motionParallax” | |
| VENDOR_ACCELERATION_GENERATOR_ENUM ::= | |
| “Glycerin 0.1.unknown” | . |
| VENDOR_ACCELERATION_OBJ ::= | // acceleration |
| objects are individually defined to match their types | |
| ACCELERATION_REFOCUS_STACK_OBJ \| | // corresponding |
| to vendor acceleration type “com.lytro.acceleration.refocusStack” | |
| //ACCELERATION_MOTION_PARALLAX_OBJ | // hypothetical, |
| corresponding to vendor acceleration type | |
| “com.lytro.acceleration.motionParallax” | |
| ACCELERATION_REFOCUS_STACK_OBJ ::= | |
| { | |
| “viewParameters” : | // may be empty. |
| { | |
| // “viewTurns” : | // optional. |
| // { | |
| // “mode” : “fixedToValue” \| “variable” \| “n/a”, | // |
| (“fixedToValue”) | |
| // “value” : TURN | // included iff |
| mode is “fixedToValue”. (0) | |
| // }, | |
| // “viewCrop” : | // optional. |
| // { | |
| // “mode” : “fixedToValue” \| “variable” \| “n/a”, | // |
| (“fixedToValue”) | |
| // “fromLeft” : PIXEL_COORD, | // (0) Pixels |
| removed from the left side of the image. | |
| // “fromTop” : PIXEL_COORD, | // (0) Pixels |
| removed from the top of the image. | |
| // “width” : PIXEL_COORD, | // |

(UNKNOWN_PIXEL_COORD) Maximum width of the resulting image. (Excess
removed from the right side.)

| | |
|---|---|
| // “height” : PIXEL_COORD | // |

(UNKNOWN_PIXEL_COORD) Maximum height of the resulting image. (Excess
removed from the bottom.)
// },
// “viewRefocusDof” :
// {
// “mode” : “fixedToValue” | “variable” | “n/a”,

| | |
|---|---|
| // “value” : “normal” \| “extended” | // included iff |
| mode is fixedToValue | |
| // }, | |
| // “viewRefocusLambda” : | |
| // { | |
| // “mode” : “fixedToValue” \| “variable” \| “n/a”, | |
| // “value” : LAMBDA | // included iff |
| mode is fixedToValue | |
| // } | |
| } | |
| “displayParameters” : | |
| { | |
| “displayDimensions” : | |
| { | |
| “mode” : “fixedToValue” \| “variable” \| “n/a”, | |
| “value” : | |
| { | |
| width : PIXEL_COORD, | |
| height : PIXEL_COORD | |
| } | |
| } | |
| }, | |
| “imageArray” : [ ACCELERATION_IMAGE_OBJ ], | // may be empty, |
| but this seems unlikely. | |
| “depthLut” : ACCELERATION_IMAGE_OBJ, | |
| “default_lambda” | |
| } | |
| ACCELERATION_IMAGE_OBJ ::= | |
| { | |
| “imageRef” : BLOBREF, | // optional |

(UNKNOWN_BLOBREF). the blobref, the http, or the inline image should be
present

| | |
|---|---|
| “imageUrl” : URL, | // optional |
| (UNKNOWN_URL). | |
| “image” : INLINE_IMAGE_OBJ, | // optional (no |
| default). | |
| “representation” : IMAGE_REPRESENTATION_ENUM, | |
| “width” : PIXEL_COORD, | |
| “height” : PIXEL_COORD, | |
| “lambda” : LAMBDA | // optional (0). |
| Required only for com.lytro.acceleration.refocusStack. | |
| } | |

### Binary Large Object (BLOB) Storage

In at least one embodiment, frame and/or picture data is stored as binary large objects (BLOBs). “Blobrefs” can be used as wrappers for such BLOBs; each blobref holds or refers to a BLOB. As described in the related U.S. patent application cross-referenced above, blobrefs can contain hash type and hash data, so as to facilitate authentication of data stored in BLOBs. In at least one embodiment, Blob servers communicate with one another to keep their data in sync, so as to avoid discrepancies in stored BLOBs. In addition, a search server may periodically communicate with one or more Blob servers in order to update its index.

### Digests

In at least one embodiment, frames 202 can be represented as digests, as described in the related U.S. patent application cross-referenced above. A hash function is defined, for generating a unique digest for each frame 202. In at least one embodiment, digests are small relative to their corresponding frames 202, so that transmission, storage, and manipulation of such digests are faster and more efficient than such operations would be on the frames 202 themselves. For example, in at least one embodiment, each digest is 256 bytes in length, although one skilled in the art will recognize that they may be of any length. A digest can also be referred to as a “hash”.

The present invention has been described in particular detail with respect to possible embodiments. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

In various embodiments, the present invention can be implemented as a system or a method for performing the above-described techniques, either singly or in any combination. In another embodiment, the present invention can be implemented as a computer program product comprising a nontransitory computer-readable storage medium and computer program code, encoded on the medium, for causing a processor in a computing device or other electronic device to perform the above-described techniques.

Reference in the specification to “one embodiment” or to “an embodiment” means that a particular feature, structure, or characteristic described in connection with the embodiments is included in at least one embodiment of the invention. The appearances of the phrase “in at least one embodiment” in various places in the specification are not necessarily all referring to the same embodiment.

Some portions of the above are presented in terms of algorithms and symbolic representations of operations on data bits within a memory of a computing device. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention can be embodied in software, firmware and/or hardware, and when embodied in software, can be downloaded to reside on and be operated from different platforms used by a variety of operating systems.

The present invention also relates to an apparatus for performing the operations herein. This apparatus may be specially constructed for the required purposes, or it may comprise a general-purpose computing device selectively activated or reconfigured by a computer program stored in the computing device. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, flash memory, solid state drives, magnetic or optical cards, application specific integrated circuits (ASICs), or any type of media suitable for storing electronic instructions, and each coupled to a computer system bus. Further, the computing devices referred to herein may include a single processor or may be architectures employing multiple processor designs for increased computing capability.

The algorithms and displays presented herein are not inherently related to any particular computing device, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description provided herein. In addition, the present invention is not described with reference to any particular programming language. It will be appreciated that a variety of programming languages may be used to implement the teachings of the present invention as described herein, and any references above to specific languages are provided for disclosure of enablement and best mode of the present invention.

Accordingly, in various embodiments, the present invention can be implemented as software, hardware, and/or other elements for controlling a computer system, computing device, or other electronic device, or any combination or plurality thereof. Such an electronic device can include, for example, a processor, an input device (such as a keyboard, mouse, touchpad, trackpad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or nonportable. Examples of electronic devices that may be used for implementing the invention include: a mobile phone, personal digital assistant, smartphone, kiosk, server computer, enterprise computing device, desktop computer, laptop computer, tablet computer, consumer electronic device, television, set-top box, or the like. An electronic device for implementing the present invention may use any operating system such as, for example: Linux; Microsoft Windows, available from Microsoft Corporation of Redmond, Wash.; Mac OS X, available from Apple Inc. of Cupertino, Calif.; iOS, available from Apple Inc. of Cupertino, Calif.; and/or any other operating system that is adapted for use on the device.

While the invention has been described with respect to a limited number of embodiments, those skilled in the art, having benefit of the above description, will appreciate that other embodiments may be devised which do not depart from the scope of the present invention as described herein. In addition, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

What is claimed is:

1. A method for transmitting image-related assets to a device, comprising:
at a processor, receiving a request for image-related assets from the device, the request comprising an indication of at least one attribute;
at the processor, based on the attribute, selecting at least one available asset from a plurality of available assets; and
transmitting the selected at least one available asset to the device.

2. The method of claim 1, wherein selecting at least one available asset comprises selecting at least one available asset based on suitability of each asset with respect to the indicated attribute.

3. The method of claim 1, wherein at least one indicated attribute specifies at least one hardware characteristic of the device.

4. The method of claim 3, wherein at least one hardware characteristic of the device comprises at least one selected from the group consisting of:
a characteristic of an output device associated with the device;
an indication of available memory;
an indication of available storage;
an indication of processing power associated with the device;
size of a screen associated with the device;
an indication as to whether a graphics processing unit is available for rendering images;
an indication as to a type of input device available to the device; and
an indication as to whether an accelerometer is available.

5. The method of claim 1, wherein at least one indicated attribute specifies at least one characteristic of software running at the device.

6. The method of claim 1, wherein at least one indicated attribute specifies at least one desired feature for displaying at least one image on the device.

7. The method of claim 6, wherein at least one desired feature comprises at least one selected from the group consisting of:
an ability to interact with an image;
an ability to refocus an image at any of a number of different focus depths;
an ability to perform depth-based processing on an image;
an ability to present an image in a three-dimensional format;
an ability to provide stereoscopic viewing of an image;
an ability to present a parallax shift for an image;
an ability to present an image having extended depth-of-field;
an ability to process different parts of an image differently depending on depicted distance;
an ability to display a sequence of images over time;
an ability to allow a user to perform at least one of adding, modifying and removing information associated with an image; and
an ability to allow a user to edit an image.

8. The method of claim 1, wherein at least one indicated attribute comprises an indication of image size.

9. The method of claim 1, wherein the steps of receiving the request and selecting at least one available asset are performed at a server, and wherein transmitting the selected at least one available asset comprises transmitting the selected at least one available asset from the server to the device.

10. The method of claim 1, wherein transmitting the selected at least one available asset to the device comprises:
providing, to the device, at least one link to at least one available asset.

11. The method of claim 1, wherein transmitting the selected at least one available asset to the device comprises:
retrieving the at least one asset from storage; and
transmitting the retrieved at least one asset to the device.

12. The method of claim 1, wherein transmitting the selected at least one available asset to the device comprises:
generating the at least one asset from stored image data; and
transmitting the generated at least one asset to the device.

13. The method of claim 12, wherein generating the at least one asset from stored image data comprises generating the at least one asset from stored light field data.

14. The method of claim 1, further comprising, subsequently to transmitting the selected at least one available asset, rendering and outputting the image at the device.

15. The method of claim 1, wherein at least one available asset comprises at least one selected from the group consisting of:
light field data;
metadata;
at least one extended depth-of-field image;
at least one sub-aperture image; and
a depth map.

16. The method of claim 1, wherein at least one available asset comprises a focus stack comprising a plurality of images associated with different focus depths.

17. The method of claim 1, wherein at least one available asset comprises a tiled focus stack, comprising a plurality of tiles representing portions of an image, wherein at least two of the tiles are associated with different focus depths.

18. The method of claim 17, wherein the tiled focus stack is generated based on determined focal depths for objects within an image.

19. The method of claim 17, further comprising:
at the processor, generating an image by blending at least two tiles in the focus stack with one another.

20. The method of claim 1, wherein at least one available asset is generated from at least one light field image.

21. A method for requesting image-related assets at a device, comprising:
at a processor, determining at least one attribute for display of an image at a device;
at the processor, determining a set of available image-related assets for display of the image;
at the processor, based on the determined attribute and the determined available assets, selecting at least one of the available assets;
at the processor, requesting the selected at least one asset from a server;
at the device, receiving the selected at least one asset from the server;
at the processor, rendering the image using the received at least one asset; and
displaying the rendered image at an output device.

22. The method of claim 21, wherein determining a set of available image-related assets comprises:
querying a server; and
receiving a response from the server, the response specifying the set of available image-related assets.

23. The method of claim 21, wherein displaying the rendered image at an output device comprises displaying an interactive image.

24. A computer program product for transmitting image-related assets to a device, comprising:
a non-transitory computer-readable storage medium; and
computer program code, encoded on the medium, configured to cause at least one processor to perform the steps of:
receiving a request for image-related assets from the device, the request comprising an indication of at least one attribute;
based on the attribute, selecting at least one available asset from a plurality of available assets; and
transmitting the selected at least one available asset to the device.

25. The computer program product of claim 24, wherein the computer program code configured to cause at least one processor to select at least one available asset comprises computer program code configured to cause at least one processor to select at least one available asset based on suitability of each asset with respect to the indicated attribute.

26. The computer program product of claim 24, wherein at least one indicated attribute specifies at least one hardware characteristic of the device.

27. The computer program product of claim 26, wherein at least one hardware characteristic of the device comprises at least one selected from the group consisting of:
a characteristic of an output device associated with the device;
an indication of available memory;
an indication of available storage;
an indication of processing power associated with the device;
size of a screen associated with the device;
an indication as to whether a graphics processing unit is available for rendering images;
an indication as to a type of input device available to the device; and
an indication as to whether an accelerometer is available.

28. The computer program product of claim 24, wherein at least one indicated attribute specifies at least one characteristic of software running at the device.

29. The computer program product of claim 24, wherein at least one indicated attribute specifies at least one desired feature for displaying at least one image on the device.

30. The computer program product of claim 29, wherein at least one desired feature comprises at least one selected from the group consisting of:
an ability to interact with an image;
an ability to refocus an image at any of a number of different focus depths;
an ability to perform depth-based processing on an image;
an ability to present an image in a three-dimensional format;
an ability to provide stereoscopic viewing of an image;
an ability to present a parallax shift for an image;
an ability to present an image having extended depth-of-field;
an ability to process different parts of an image differently depending on depicted distance;
an ability to display a sequence of images over time;
an ability to allow a user to perform at least one of adding, modifying and removing information associated with an image; and
an ability to allow a user to edit an image.

31. The computer program product of claim 24, wherein at least one indicated attribute comprises an indication of image size.

32. The computer program product of claim 24, wherein the computer program code configured to cause at least one processor to transmit the selected at least one available asset to the device comprises:
computer program code configured to cause at least one processor to provide, to the device, at least one link to at least one available asset.

33. The computer program product of claim 24, further comprising computer program code configured to cause at least one processor to, subsequently to transmitting the selected at least one available asset, render and output the image at the device.

34. The computer program product of claim 24, wherein at least one available asset comprises at least one selected from the group consisting of:
light field data;
metadata;
at least one extended depth-of-field image;
at least one sub-aperture image; and
a depth map.

35. The computer program product of claim 24, wherein at least one available asset comprises a focus stack comprising a plurality of images associated with different focus depths.

36. The computer program product of claim 24, wherein at least one available asset comprises a tiled focus stack, comprising a plurality of tiles representing portions of an image, wherein at least two of the tiles are associated with different focus depths.

37. The computer program product of claim 36, wherein the tiled focus stack is generated based on determined focal depths for objects within an image.

38. The computer program product of claim 36, further comprising computer program code configured to cause at least one processor to generate an image by blending at least two tiles in the focus stack with one another.

39. The computer program product of claim 24, wherein at least one available asset is generated from at least one light field image.

40. A computer program product for requesting image-related assets at a device, comprising:
a non-transitory computer-readable storage medium; and
computer program code, encoded on the medium, configured to cause at least one processor to perform the steps of:
determining at least one attribute for display of an image at a device;
determining a set of available image-related assets for display of the image;
based on the determined attribute and the determined available assets, selecting at least one of the available assets;
requesting the selected at least one asset from a server;
receiving the selected at least one asset from the server;
rendering the image using the received at least one asset; and
displaying the rendered image at an output device.

41. The computer program product of claim 40, wherein the computer program code configured to cause at least one processor to determine a set of available image-related assets comprises computer program code configured to cause at least one processor to perform the steps of:
querying a server; and
receiving a response from the server, the response specifying the set of available image-related assets.

42. A system for transmitting image-related assets to a device, comprising:
a processor, configured to receive a request for image-related assets from the device, the request comprising an indication of at least one attribute, and to, based on the attribute, selecting at least one available asset from a plurality of available assets; and
a transmitter, communicatively coupled to the processor, configured to transmit the selected at least one available asset to the device.

43. The system of claim 42, wherein the processor is configured to select at least one available asset by selecting at least one available asset based on suitability of each asset with respect to the indicated attribute.

44. The system of claim 42, wherein at least one indicated attribute specifies at least one hardware characteristic of the device.

45. The system of claim 44, wherein at least one hardware characteristic of the device comprises at least one selected from the group consisting of:
a characteristic of an output device associated with the device;
an indication of available memory;
an indication of available storage;
an indication of processing power associated with the device;
size of a screen associated with the device;
an indication as to whether a graphics processing unit is available for rendering images;
an indication as to a type of input device available to the device; and
an indication as to whether an accelerometer is available.

46. The system of claim 42, wherein at least one indicated attribute specifies at least one characteristic of software running at the device.

47. The system of claim 42, wherein at least one indicated attribute specifies at least one desired feature for displaying at least one image on the device.

48. The system of claim 47, wherein at least one desired feature comprises at least one selected from the group consisting of:
an ability to interact with an image;
an ability to refocus an image at any of a number of different focus depths;
an ability to perform depth-based processing on an image;
an ability to present an image in a three-dimensional format;
an ability to provide stereoscopic viewing of an image;
an ability to present a parallax shift for an image;
an ability to present an image having extended depth-of-field;
an ability to process different parts of an image differently depending on depicted distance;
an ability to display a sequence of images over time;
an ability to allow a user to perform at least one of adding, modifying and removing information associated with an image; and
an ability to allow a user to edit an image.

49. The system of claim 42, wherein at least one indicated attribute comprises an indication of image size.

50. The system of claim 42, wherein the transmitter is configured to transmit the selected at least one available asset to the device by providing, to the device, at least one link to at least one available asset.

51. The system of claim 42, further comprising:
a renderer, communicatively coupled to the transmitter, configured to render the image; and
an output device, communicatively coupled to the renderer, configured to display the image.

52. The system of claim 42, wherein at least one available asset comprises at least one selected from the group consisting of:
light field data;
metadata;
at least one extended depth-of-field image;
at least one sub-aperture image; and
a depth map.

53. The system of claim 42, wherein at least one available asset comprises a focus stack comprising a plurality of images associated with different focus depths.

54. The system of claim 42, wherein at least one available asset comprises a tiled focus stack, comprising a plurality of tiles representing portions of an image, wherein at least two of the tiles are associated with different focus depths.

55. The system of claim 54, wherein the tiled focus stack is generated based on determined focal depths for objects within an image.

56. The system of claim 54, further comprising a renderer, communicatively coupled to the transmitter, configured to generate an image by blending at least two tiles in the focus stack with one another.

57. The system of claim 42, wherein at least one available asset is generated from at least one light field image.

58. A system for requesting image-related assets at a device, comprising:
a processor, configured to perform the steps of:
determining at least one attribute for display of an image at a device;
determining a set of available image-related assets for display of the image; and
based on the determined attribute and the determined available assets, selecting at least one of the available assets;
a communication module, communicatively coupled to the processor, configured to perform the steps of:
requesting the selected at least one asset from a server;
receiving the selected at least one asset from the server;
a renderer, communicatively coupled to the communication module, configured to render the image using the received at least one asset; and
an output device, communicatively coupled to the renderer, configured to display the image.

59. The system of claim 58, wherein the processor is configured to determine a set of available image-related assets by performing the steps of:
querying a server; and
receiving a response from the server, the response specifying the set of available image-related assets.
